(19) United States
(12) Patent Application Publication
(10) Pub. No.: US 2009/0229950 A1
(43) Pub. Date: Sep. 17, 2009

(54) Verification system and banknote-and-coin handling system

(75) Inventor: Tasuku Nakamoto, Ako-Shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Glory Ltd., Himeji-shi (JP)

(21) Appl. No.: 12/315,924

(22) Filed: Dec. 8, 2008

Related U.S. Application Data
(63) Continuation-in-part of application No. 12/077,024, filed on Mar. 14, 2008.

(51) Int. Cl. G07D 7/02; G07D 5/00

(52) U.S. Cl. 194/302

(57) ABSTRACT

A verification system for a banknote-and-coin handling system includes a banknote machine for depositing, dispensing, and sorting, a coin machine for depositing, dispensing, and sorting, and a monitor server. The coin machine for depositing, dispensing, and sorting includes a hopper, a discriminating portion, and coin storage portions. The banknote machine for depositing, dispensing, and sorting includes a banknote input portion, a deposit discriminating unit, and banknote storage portions. The monitoring server includes a verification instructing unit and a verification command transmitting unit. The banknote-and-coin handling system further includes a verification processing unit executing a verification process based on the verification command transmitted by said verification command transmitting unit, and a verification result transmitting unit transmitting a result of the verification of said verification processing unit to said monitor server.

### CROSS-REFERENCE TO RELATED APPLICATION

This is a Continuation-in-part of U.S. application Ser. No. 12/077,024 filed on Mar. 14, 2008 (now pending), the entirety of which is incorporated herein by reference.

### TECHNICAL FIELD OF THE INVENTION

The present invention relates generally to a verification system for a banknote-and-coin handling system and to the banknote-and-coin handling system employed in, e.g., a financial institution, and more particularly to a verification system for a banknote-and-coin handling system and to the banknote-and-coin handling system, which are capable of depositing and dispensing and sorting loose banknotes, bundled banknotes, loose coins and packed coins in a variety of modes.

### BACKGROUND OF THE INVENTION

The financial institution such as a bank deals with a variety of currencies such as the loose banknotes, the bundled banknotes, the loose coins and the packed coins.

A banknote-related handling apparatus (refer to, e.g., Japanese Patent Application Laid-Open Publication No. 2003-141598) and a coin-related handling apparatus (refer to, e.g., Japanese Patent Application Laid-Open Publication No. 2005-228079) have hitherto been developed, and a banknote-and-coin handling system is built up by arranging these single-function apparatuses in a side-by-side relation.

The conventional banknote-and-coin handling system does not, however, unify sizes and functions of these single-function apparatuses, resulting in such problems that space efficiency does not reach an acceptable level, the necessary functions are not realized in some case, and the operations are so complicated as to induce mistakes.

Further, as in the case of the banknote-and-coin handling system installed in a cashier room, the verification has hitherto been performed one or twice a month. In this case, there exists a problem that a person in charge of the banknote-and-coin handling system unlawfully takes and brings the cash out of the banknote-and-coin handling system by use of a key, then temporarily borrows the cash from another banknote-and-coin handling system only when verified, subsequently inputs the cash into a storage box by employing the key, and conducts the verification in a way that pretends a normal state of the verification result, thus performing the unlawful act.

In terms of storing tremendously a large amount of moneys in the banknote-and-coin handling system installed in the cashier room, it is quite time-consuming to discriminate between and count all the moneys by feeding the moneys out of the storage box on a one-by-one basis and to return the moneys into the storage box. This operation entails stopping banking operations under the verification if conducted in the operation time, and it follows that the verification is carried out after finishing other operations. Generally, the banking operations are not finished till the verification is terminated, and hence there is a problem that the person, as a matter of course, in charge of the banknote-and-coin handling system and all the bank clerks are restricted late in the night depending on the situation.

Further, if a fault (such as a deficiency in the number of moneys and a mixture of abnormal banknotes) would occur in the banknote bundle later on due to a mistake of an operator (a person in charge of treatment), a follow-up examination for specifying a cause thereof etc is needed. The follow-up examination can not be, however, easily conducted based on only information such as a serial number.

If failing to clear sum-up data and to switch OFF a power source concurrently, the data has hitherto been enabled to be inputted even when the date changed, in which case a problem is that the deposit and dispensation processes are performed without being aware of the abnormal state.

Still another problem is that a recovery process from the deficiency of the cash under the dispensation and occurrence of a trouble in a lobby machine etc takes a considerable period of time, with the result that the customers must wait. Yet another problem is that the person in charge implements calculations when in the recovery process, and therefore the efficiency decreases.

Furthermore, a scheme in the prior art is that in the case of executing the deposit and dispensation processes and the dispensation process in parallel, if a banknote jam occurs during any one of both processes, the clerk in charge removes the jammed banknotes and the banknotes in the middle of being carried after finishing the other process, and another process may resume. If the banknote jam occurs likewise during the other process, however, the clerk in charge must discriminate between the jammed banknotes and the banknotes in the middle of being carried into deposit banknotes and dispensation banknotes and then must remove these banknotes. If a misjudgment is made, such a problem arises that a variety of discrepancies in calculations occur.

### SUMMARY OF THE INVENTION

Under such circumstances, it is an object of the present invention to provide a verification system for a banknote-and-coin handling system having a compact configuration and the banknote-and-coin handling system, which are capable of uniformly setting a variety of functions.

According to a first aspect of the invention, there is provided that a verification system for a banknote-and-coin handling system, comprising:

a banknote machine for depositing, dispensing, and sorting that handles banknotes and a coin machine for depositing, dispensing, and sorting that handles coins; and

a monitor server connected to said banknote-and-coin handling system,

said coin machine for depositing, dispensing, and sorting including:

a hopper accepting inputted loose coins;

a discriminating portion discriminating between the loose coins accepted by said hopper; and

coin storage portions stored with the loose coins on a denomination-by-denomination basis on the basis of a result of the distinction made by said discriminating portion,

said banknote machine for depositing, dispensing, and sorting including:

a banknote input portion accepting the inputted loose banknotes;

a deposit discriminating unit discriminating the loose banknotes accepted by said banknote input portion; and

banknote storage portions stored with the loose banknotes on the denomination-by-denomination basis on the basis of a result of the distinction made by said deposit discriminating unit,

said monitoring server including:

a verification instructing unit giving a verification instruction; and

a verification command transmitting unit transmitting a verification command to said banknote-and-coin handling system on the basis of the verification instruction given by said verification instructing unit,

wherein said banknote-and-coin handling system further includes:

a verification processing unit executing a verification process based on the verification command transmitted by said verification command transmitting unit; and

a verification result transmitting unit transmitting a result of the verification of said verification processing unit to said monitor server.

According to the another aspect of the invention, a verification system for a banknote-and-coin handling system, further comprising a central terminal connected to said monitor server,

wherein said monitor server further includes:

a judging unit making a judgment about a verification result transmitted from said verification result transmitting unit; and

a judgment result transmitting unit transmitting a judgment result of said judging unit to said central terminal.

According to the another aspect of the invention, a verification system for a banknote-and-coin handling system, wherein said verification command transmitting unit transmits the verification command off an operation time.

According to the another aspect of the invention, a verification system for a banknote-and-coin handling system, wherein said monitor server further includes a verification reservation setting unit that sets a verification reservation date and time, and

said verification command transmitting unit transmits the reservation date and time set by said verification reservation setting unit.

According to the another aspect of the invention, a verification system for a banknote-and-coin handling system, wherein said verification reservation setting unit unperiodically sets the reservation date and time.

According to the another aspect of the invention, a verification system for a banknote-and-coin handling system, wherein said verification reservation setting unit sets the reservation date and time at intervals of a predetermined period.

According to the another aspect of the invention, a verification system for a banknote-and-coin handling system, wherein said verification command transmitting unit makes a choice at intervals of one day and transmits the verification command when the choice is hit.

According to the another aspect of the invention, a verification system for a banknote-and-coin handling system, wherein said verification processing unit counts the loose coins stored in said coin storage portions and the loose banknotes stored in said banknote storage portions, and said verification result transmitting unit transmits end information, a count result of said verification processing unit and balance data of the loose coins and the loose banknotes to said monitor server.

According to the another aspect of the invention, a verification system for a banknote-and-coin handling system, wherein said verification processing unit counts the loose coins and the loose banknotes excluding reject coins and reject banknotes.

According to the another aspect of the invention, a verification system for a banknote-and-coin handling system, wherein said verification processing unit counts the reject coins accepted by said hopper and the reject banknotes accepted by said banknote input portion.

According to the another aspect of the invention, a verification system for a banknote-and-coin handling system, wherein said verification result transmitting unit transmits a mail showing the verification result to said monitor server.

According to the another aspect of the invention, a verification system for a banknote-and-coin handling system, wherein said verification result transmitting unit transmits a mail showing the verification result to a mobile communication terminal.

According to a second aspect of the invention, there is provided that a banknote-and-coin handling system comprising;

a banknote machine for depositing, dispensing, and sorting that handles banknotes; and

a coin machine for depositing, dispensing, and sorting that handles coins,
said coin machine for depositing, dispensing, and sorting including:

a hopper accepting inputted loose coins;

a discriminating portion discriminating between the loose coins accepted by said hopper;

coin storage portions stored with the loose coins on a denomination-by-denomination basis on the basis of a result of the distinction made by said discriminating portion; and

a coin packing unit taking a predetermined number of loose coins out of said coin storage portions and packing the predetermined number of taken-out coins into packed coins,

said banknote machine for depositing, dispensing, and sorting including:

a banknote input portion accepting the inputted loose banknotes;

a deposit discriminating unit discriminating the loose banknotes accepted by said banknote input portion;

banknote storage portions stored with the loose banknotes on the denomination-by-denomination basis on the basis of a result of the distinction made by said deposit discriminating unit; and

a bundle printing unit feeding out a predetermined number of loose banknotes from said banknote storage portions, bundling the predetermined number of fed-out loose banknotes with a bundling band into a banknote bundle, and a piece of printing processing information showing a content of the process conducted for the banknote bundle on the bundling band.

According to the another aspect of the invention, a banknote-and-coin handling system, wherein said bundle printing unit prints off-machine banknote information when the banknote bundle is organized by the loose banknotes accepted by said banknote input portion, and prints in-machine banknote information when the banknote bundle is organized by the banknotes stored in said banknote storage portions.

According to the another aspect of the invention, a banknote-and-coin handling system, wherein said bundle printing unit prints discharge banknote bundle information when the banknote bundle is discharged outside said machine, and prints storage banknote bundle information when the banknote bundle is stored inside said machine.

According to the another aspect of the invention, a banknote-and-coin handling system, wherein said bundle printing unit prints processing time information that represents time of a process executed for the banknote bundle.

According to the another aspect of the invention, a banknote-and-coin handling system, wherein said bundle printing unit prints operator information that specifies an operator involved in the process executed for the banknote bundle.

### BRIEF DESCRIPTION OF THE DRAWINGS

FIG. 1 is a perspective view showing an external appearance of a banknote and coin handling system in one embodiment of the present invention.

FIG. 2 is a perspective view showing an external appearance of the banknote and coin handling system in a modified embodiment illustrated in FIG. 1.

FIG. 3 is a perspective view showing an external appearance of the banknote and coin handling system in another modified embodiment illustrated in FIG. 1.

FIG. 4 is a perspective view illustrating only banknote handling components in FIG. 1.

FIG. 5 is a vertical sectional view schematically showing an internal structure of a bundle sorting dispensation unit in a banknote handling apparatus illustrated in FIG. 1.

FIGS. 6A and 6B are enlarged views of a peripheral portion (when in a banknote bundle storage process) of a banknote bundle carrying path in the bundle sorting dispensation unit shown in FIG. 5; FIG: 6A is a plan view; and FIG. 6B is a vertical sectional view.

FIGS. 7A and 7B are enlarged views of the peripheral portion (when in a banknote bundle ejecting process) of the banknote bundle carrying path in the bundle sorting dispensation unit shown in FIG. 5; FIG. 7A is a plan view; and FIG. 7B is a vertical sectional view.

FIG. 8 is a plan view showing an operation of a nipping portion of a bundle carrying unit common to the bundle sorting dispensation unit and a loose banknote deposit and dispensation unit in terms of a relation with part of the respective handling units.

FIG. 9 is a vertical sectional view schematically illustrating an internal structure of the loose banknote deposit and dispensation unit in the banknote handling apparatus illustrated in FIG. 1.

FIG. 10 is a schematic view of the internal structure, showing an internal structure of a new banknote dispensation unit shown in FIG. 1 and a flow of the banknotes.

FIGS. 11A-11C are views showing in sequence how an out-of-machine bundle loading process is executed by a banknote bundle handling unit illustrated in FIG. 5.

FIGS. 12A-12C are views showing in sequence how an auto careful inspection process is executed by the banknote bundle handling unit illustrated in FIG. 5.

FIGS. 13A-13C are views showing in sequence how an auto allocation process is executed by the banknote bundle handling unit illustrated in FIG. 5.

FIG. 14 is a vertical sectional view schematically showing an internal structure of a coin handling unit partly constituting the banknote and coin handling system illustrated in FIG. 1.

FIG. 15 is a plan view schematically showing a main configuration in FIG. 14.

FIG. 16 is a side view showing a layout of coin storage portions of the lose coin deposit and dispensation unit.

FIG. 17 is a sectional view of the main configuration related to storing wrapped coins as viewed from a right side front side in FIG. 14.

FIG. 18 is a perspective view showing one example of a wrapped coin storage portion.

FIG. 19 is a block diagram showing architecture of the verification system for the banknote-and-coin handling system according to the first embodiment of the present invention.

FIG. 20 is a block diagram showing a configuration of the banknote-and-coin handling system 300 according to the first embodiment of the present invention.

FIG. 21 is a block diagram showing a configuration of the monitor server 320 according to the first embodiment of the present invention.

FIG. 22 is a flowchart showing a handling procedure of the verification system for the banknote-and-coin handling system 300 according to the first embodiment of the present invention.

FIG. 23 is a flowchart showing a handling procedure of a judging process according to the first embodiment of the present invention.

FIG. 24 is a flowchart showing a handling procedure of the verification system for the banknote-and-coin handling system 300 according to the first modified example of the first embodiment of the present invention.

FIG. 25 is a flowchart showing a processing procedure of the verification process according to the second modified example of the first embodiment of the present invention.

FIG. 26 is a schematic view showing a verification command screen.

FIG. 27 is a schematic view showing a menu screen.

FIG. 28 is a schematic view showing a user setting screen.

FIG. 29 is a schematic view showing a night-time automatic verification setting screen.

FIG. 30A is a schematic view showing a surface of a banknote with processing information printed on the binding band.

FIG. 30B is a schematic view showing a undersurface of a banknote with processing information printed on the binding band.

FIG. 31 is a block diagram illustrating a configuration of a banknote-and-coin handling system 400 according to the third embodiment of present invention.

FIG. 32 is a flowchart showing a handling procedure when the banknote-and-coin handling system 400 according to the third embodiment of present invention normally operates.

FIG. 33 is a flowchart showing a processing procedure of a date change screen displaying process according to the third embodiment of present invention.

FIG. 34 is a schematic view showing a standby screen.

FIG. 35 is a schematic view showing a date change screen.

FIG. 36 is a schematic view showing a main menu screen.

FIG. 37 is a flowchart showing a processing procedure of the advancing process (S3205 in FIG. 32) according to the third embodiment of present invention.

FIG. 38 is a flowchart showing a handling procedure of a clearing process (S3206 in FIG. 32) according to the third embodiment of present invention.

FIG. 39 is a schematic view showing an alarm screen.

FIG. 40 is a flowchart showing a processing procedure of a restart process (S3307 in FIG. 33) according to the third embodiment of present invention.

FIG. 41 is a schematic view showing a clear-indication.

FIG. 42 is a block diagram showing a topology of a banknote-and-coin handling system 500 according to the fourth embodiment of the present invention at a financial business office.

FIG. 43 is a block diagram illustrating architecture of the banknote-and-coin handling system 500 according to the fourth embodiment of the present invention.

FIG. 44 to FIG. 46 are flowcharts showing a processing procedure of an advanced dispensation process according to the forth embodiment of present invention.

FIG. 47 is a schematic view showing a menu screen.

FIG. 48 is a schematic view showing an acceptance list.

FIG. 49 is a flowchart showing a processing procedure of a continuous deposit process according to the forth embodiment of present invention.

FIG. 50 is a schematic view showing a customer treatment menu.

FIG. 51 is a schematic view showing a selection menu.

FIG. 52 is a flowchart showing a processing procedure of a continuous deposit process according to the forth embodiment of present invention.

FIG. 53 and FIG. 54 are flowcharts showing a processing procedure of a payback take-over process according to the forth embodiment of present invention.

FIG. 55 and FIG. 56 are flowcharts showing a handling procedure of the exchange process according to the fourth embodiment of the present invention.

FIG. 57 is a flowchart showing a handling procedure of a deposit and dispensation process by a loose banknote deposit and dispensation unit 103 according to the fifth embodiment of the present invention.

### DETAILED DESCRIPTION OF THE EXEMPLARY EMBODIMENT

An in-depth description of an embodiment of a banknote and coin handling system according to the present invention will hereinafter be made.

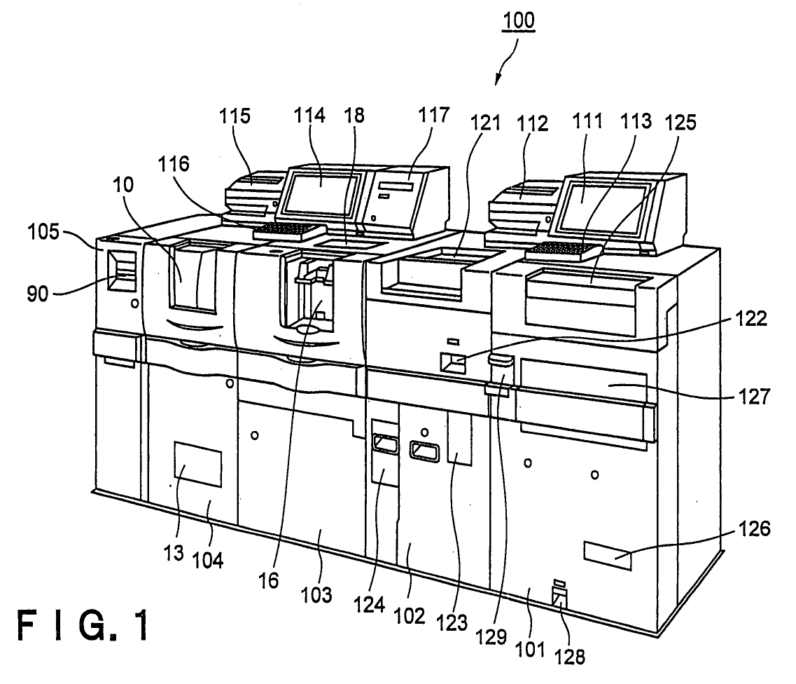

FIG. 1 is a perspective view illustrating architecture of a whole banknote and coin handling system 100 according to the present invention. The banknote and coin handling system 100 is a side-by-side installment type of banknote and coin handling system including five handling apparatuses 101-105 that are connected to each other. The handling apparatuses 101-105 are, from the right side, a packaged coin dispensation unit 101, a loose coin deposit and dispensation unit 102, a loose banknote deposit and dispensation unit 103, a bundle sorting dispensation unit 104 and a new banknote dispensation unit 105. The loose banknote deposit and dispensation unit 103, the bundle sorting dispensation unit 104 and the new banknote dispensation unit 105 build up a banknote machine for depositing, dispensing, and sorting, and the packaged coin dispensation unit 101 and the loose coin deposit and dispensation unit 102 build up a coin machine for depositing, dispensing, and sorting.

The respective apparatuses are coincident in terms of heights of their housings, and can be connected to each other with a sense of uniformity. It is desirable that depths of the individual apparatuses be equalized. The three banknote-oriented apparatuses and the two coin-oriented apparatuses can be respectively connected, and a system arrangement may be done irrespective of a right-and-left positional relation between the banknote-oriented units and the coin-oriented units. Therefore, the architecture in FIG. 1 can be changed without any restrictions according to the necessity, such as a layout of replacing the banknote-oriented units and the coin-oriented units with each other.

Upper surfaces of the housings of the packaged coin dispensation unit 101 and the loose coin deposit and dispensation unit 102 are provided with a terminal unit 111 for displaying and operating a screen, a printer unit 112 that performs printing and a keyboard 113. Upper surfaces of the housings of the loose coin deposit and dispensation unit 102 and the loose banknote deposit and dispensation unit 103 (the loose banknote deposit and dispensation unit 103 and the bundle sorting dispensation unit 104) are likewise provided with a terminal unit 114, a printer unit 115 and a keyboard 116. Provided further is a post unit 117 into which unfit banknotes, checks, etc are inserted.

The present embodiment involves providing the terminal units and the printer units by twos, however, these units are the same other than such setting that one units are used as main units while the others are employed as sub-units.

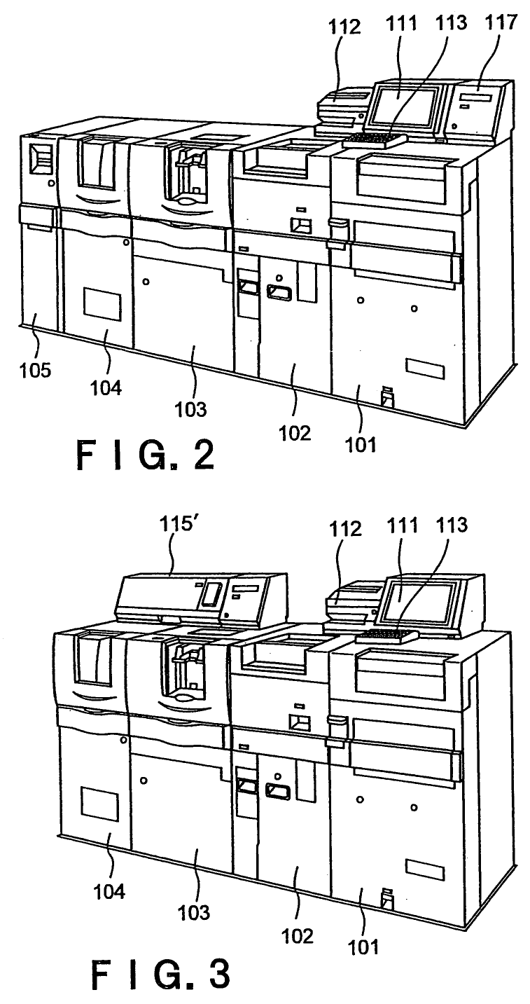

Accordingly, as illustrated in FIG. 2, the system can be so configured as to include only one set of the terminal unit 111, the printer unit 112, keyboard 113 and the post unit 117.

Note that the new banknote dispensation unit 105 is illustrated by way of an example of a vertical placement type in FIGS. 1 and 2, and can be also placed as a lateral placement type 105′. In this case, an occupied area can be reduced, and the terminal unit 111, the printer unit 112 and the keyboard 113 are provided by ones in terms of the space.

Each of the handling units will hereinafter be described.

### 1. Banknote Handling Unit

As described above, the banknote and coin handling system 100 according to the present invention is roughly constructed of the loose banknote deposit and dispensation unit 103, the bundle sorting dispensation unit 104, the new banknote dispensation unit 105, the packaged coin dispensation unit 101 that deals with the coins and the loose coin deposit and dispensation unit 102. In the following discussion, however, the loose banknote deposit and dispensation unit 103, the bundle sorting dispensation unit 104 and the new banknote dispensation unit 105, which build up the banknote machine for depositing, dispensing, and sorting of the banknote-oriented units, will be explained.

### (1) Bundle Sorting Dispensation Unit 104

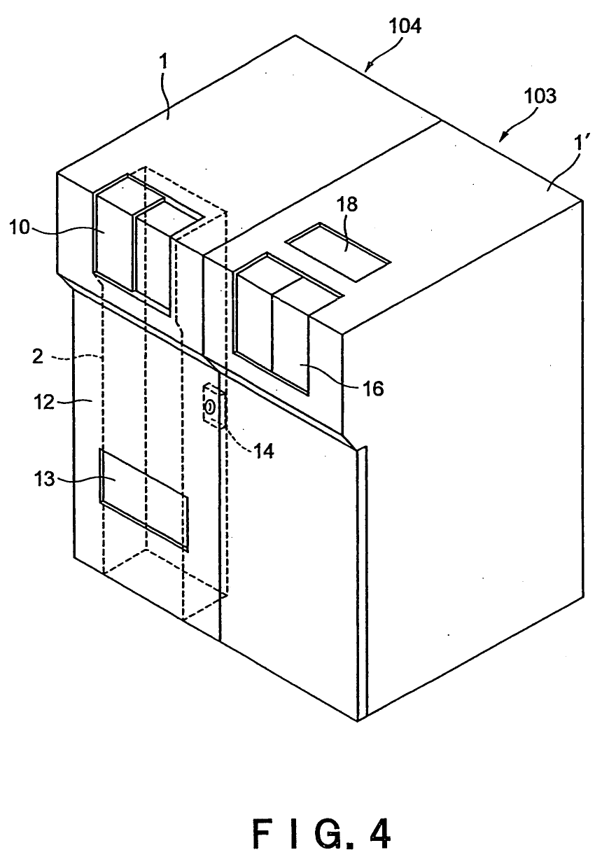

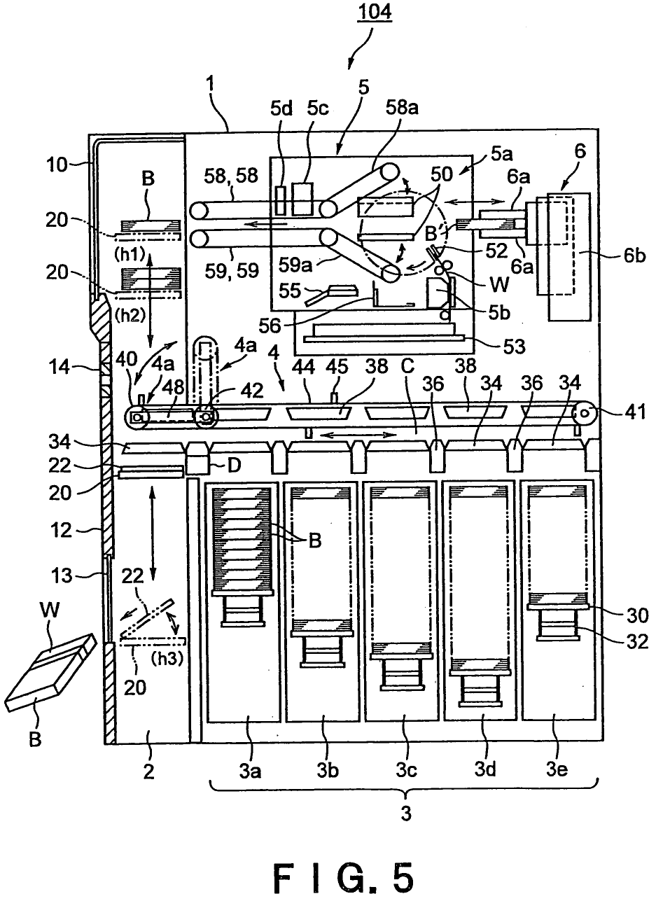

FIG. 1 illustrates an external appearance of the whole system. FIG. 4 illustrates external appearances of the loose banknote deposit and dispensation unit 103 and the bundle sorting dispensation unit 104. FIG. 5 schematically illustrates an internal structure thereof. As shown in FIGS. 1, 4 and 5, the bundle sorting dispensation unit 104 includes a bundle carrying unit 6 (which will be described later on) for carrying in a loose banknote bundle B′ from the loose banknote deposit and dispensation unit 103 that will be explained later on, a binding print unit 5 that binds a predetermined number of loose banknote bundles B′ with a binding band (binder) W into a banknote bundle B and performs a predetermined print on the binding band W, a banknote bundle ascending and descending path (banknote bundle accepting unit) 2 for moving the banknote bundle B undergoing the binding and printing process by the binding print unit 5 in a vertical direction, and a banknote bundle storage unit 3 that stores the banknote bundles B. Further, the bundle sorting dispensation unit 104 includes a carrying unit (loading unit) 4 that moves the banknote bundle B in a horizontal direction between the ascending and descending path 2 and the storage unit 3, and a bundle discriminating unit (discriminating unit) D that discriminates between denominations of the banknote bundles B carried by the carrying unit 4.

A housing 1 illustrated in FIG. 5 houses the ascending and descending path 2, the storage unit 3, the carrying unit 4 and the binding print unit 5, and the bundle carrying unit 6 moves within the housing 1 (and a housing 1′ for the loose banknote deposit and dispensation unit 103, which will be described later on).

The banknote ascending and descending path 2 is disposed along the front side of the housing 1, and is provided inside with an ascending and descending stage (loading unit) 20 that ascends and descends while being loaded with the banknote bundles B. An inclined plate 22 swingable to tilt the front is provided on an upper surface side of the ascending and descending stage 20. An upper portion of the ascending and descending path 2 is communicable with the outside via a shutter opening and closing type of a bundle dispensation port 10. Moreover, a lower part of the ascending and descending path 2 is opened on the whole by opening forward an opening and closing door 12 attached with a locking device 14 and is also communicable partially with the outside via a shutter opening and closing type of a bundle out-of-machine ejection port 13 provided at the opening and closing door 12.

The banknote bundle storage unit 3 has five bundle storage portions 3a-3e disposed in line in back-and-forth directions. The bundle storage portions 3a-3e are classified into the four denomination bundle storage portions 3a-3d for storing the banknote bundles B on a denomination-by-denomination basis and the batch manner bundle storage portion 3e for storing batch manner the banknote bundles B in a multi-denomination state. Note that the functions of the respective storage portions and the denominations can be flexibly set and changed, and it is feasible to provide a plurality of storage portions for specified denominations and provide a plurality of batch manner storage portions.

Each of the bundle storage portions 3a-3e is of an independently attachable and detachable cassette type, with its upper end portion being opened, and is provided inside with an ascending and descending stage 300 fitted with a pantograph mechanism 32.

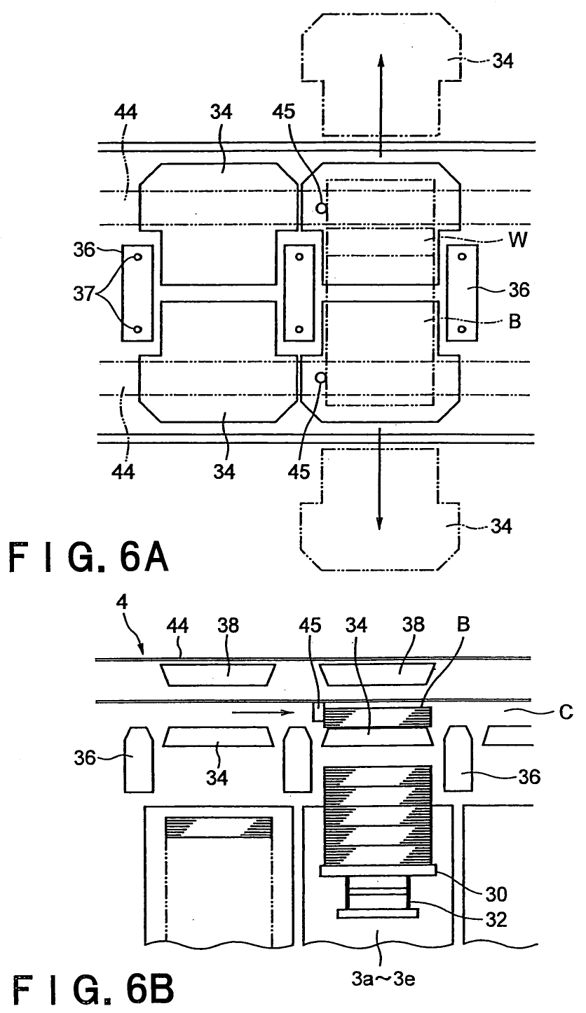

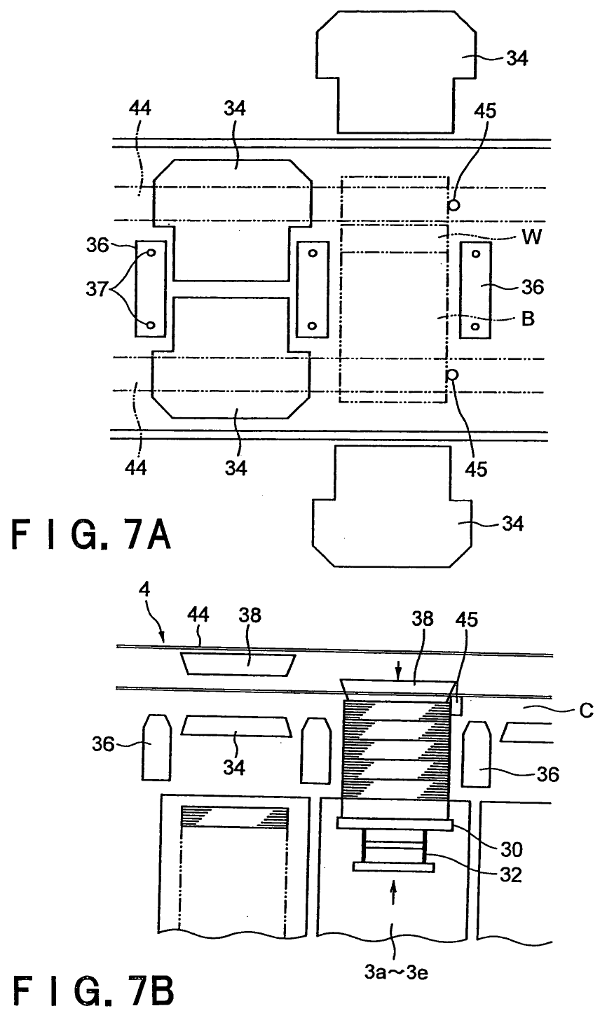

FIGS. 6 and 7 are diagrams each showing in enlargement peripheral portions of the banknote bundle carrying path in the banknote handling unit illustrated in FIG. 5 when inserting the banknote bundle and when ejecting the banknote bundle. FIGS. 6A and 7A are plan views, and FIGS. 6B and 7B are vertical sectional views.

The carrying unit 4 has a pair of left-and-right conveying belts 44 (see FIG. 6A) extending horizontally to within the ascending and descending path 2 from above the storage unit 3. Each conveying belt 44 is stretched between a pair of pulleys 40, 41 and is provided with four pieces of pins 45 protruding at predetermined intervals. For each of the conveying belts 44, a third pulley 42 is disposed between the pair of pulleys 40, 41 (just posterior to the ascending and descending path 2). Then, a lever 48 connecting the two pulleys 40, 42 on the side of the ascending and descending path 2 is swingable through 90 degrees upward about an axis of rotation of the pulley 42. With this contrivance, the portion, on the side of the ascending and descending path 2, of the carrying unit 4 swings to a vertical retreat position from a horizontal carry position, thereby forming a swing retreat portion 4a enabling the retreat from within the ascending and descending path 2.

A pair of opening and closing plates 34 (see FIG. 6) opening and closing rightward and leftward is provided respectively between the carrying unit 4 and each of the bundle storage portions 3a-3e. Moreover, a pair of opening and closing plates 34 is similarly provided between the swing retreat portion 4a of the carrying unit 4 and the lower part of the ascending and descending path 2. A partition plate 36 is provided respectively between the opening and closing plates 34 corresponding to the individual bundle storage portions 3a-3e. A pair of sensors 37 (FIG. 6A) for detecting passage and a skew of the banknote bundle B is provided on an upper edge face of each partition plate 36. The bundle discriminating unit D is disposed between the opening and closing plate 34 on the bundle storage portion 3a and the opening and closing plate 34 within the ascending and descending path 2.

A carrying path C along which to convey the banknote bundle B in the horizontal direction is formed between the opening and closing plate 34, the partition plate 36, the bundle discriminating unit D and the carrying unit 4. To be specific, the banknote bundle B, which receives carrying force from a pin 45 of the conveying belt 44 within the carrying path C, is carried while sliding on the opening and closing plate 34 etc (see FIG. 5). Note that a pressing force detection plate 38 in a face-to-face relationship with the opening and closing plate 34 on each of the bundle storage portions 3a-3e is disposed between the pair of conveying belts 44.

Herein, an explanation of how the banknote bundle B is inserted into and ejected from each of the bundle storage portions 3a-3e, will be made with reference to FIGS. 6 and 7. Note that the discussion will proceed in a way that does not specify any one of the bundle storage portions but generically applies the bundle storage portions 3a-3e in FIGS. 6 and 7.

When storing the banknote bundle B as shown in FIG. 6, to begin with, the banknote bundle B is carried by the carrying unit 4 to above the opening and closing plates 34 corresponding to the should-be-stored bundle storage portions 3a-3e. On the other hand, within the bundle storage portions 3a-3e, the ascending and descending stage 30 rises to a height at which to receive the banknote bundle B to be stored (FIG. 6B). In this state, the pair of opening and closing plates 34 is opened rightward and leftward (FIG. 6A), thereby dropping the banknote bundle B down onto the ascending and descending stage 30 (on the banknote bundle B stacked on this stage 30). Thereafter, the pair of opening and closing plates 34 is closed, and the ascending and descending stage 30 descends to a predetermined position, thus completing the storage of the banknote bundle B.

Next, when ejecting the banknote bundle B as shown in FIG. 7, the opening and closing plates 34 above the bundle storage portions 3a-3e from which the banknote bundle B should be ejected, open rightward and leftward, and the ascending and descending stage 30 on which the banknote bundle B is placed ascends. At this time, the pressing force detection plate 38 descends synchronizing with the opening of the opening and closing plates 34 and regulates a rising height of the banknote bundle B. To be specific, the pressing force detection plate 38, when pushed up by the uppermost banknote bundle B, functions as a switch that stops the ascendance of the stage 30. With this operation, only the uppermost banknote bundle B can be ejected onto the carrying path C, thus enabling the banknote bundles B to be carried on a bundle-by-bundle basis by the carrying unit 4.

Subsequently, the binding print unit 5 illustrated in FIG. 5 includes a binding unit 5a for binding a loose banknote bundle B′ carried by the bundle carrying unit 6 with a binding band W into the banknote bundle B, and a printer (printing unit) 5b for performing a predetermined print etc on the binding band W of the banknote bundle B. The binding unit 5a has a nipping unit 50 that nips the loose banknote bundle B′, and a rotary arm 52 for winding the binding band W (drawn from a roll 53) around the nipped bindle B′. This binding unit 5a can involve using a known type of binding device. The binding unit 5a has, in addition, a bonding trowel 55 that bonds the edges of the wound binding band W, and a cutter 56 that cuts the binding band W on the bundle-by-bundle basis. Note that a band winding position of the bundled banknotes is changeable because of differences depending on countries, districts, etc.

Then, a content of how the band is wound can be changed depending on a characteristic of the banknotes that should be bundled. For example, a positional change of winding the bands around fit (normal) banknotes and unfit banknotes facilitates the banknote management within a financial institution, and hence, for example, it is possible to control winding the band around the fit banknotes in a position slightly deviating from the center and around the unfit banknotes at the center.

Further, a sheet of winding band paper may be fixed irrespective of the denominations, however, it is feasible to facilitate distinction between the denominations of the bundled banknotes and the banknote management as well by use of the sheets of winding band paper different according to the categories of the denominations in a way that enables plural types of winding band paper to be supplied.

In another mode, the same winding band paper is applied to each of the denominations, and a post-bundling winding band paper can be marked with a color corresponding to the denomination.

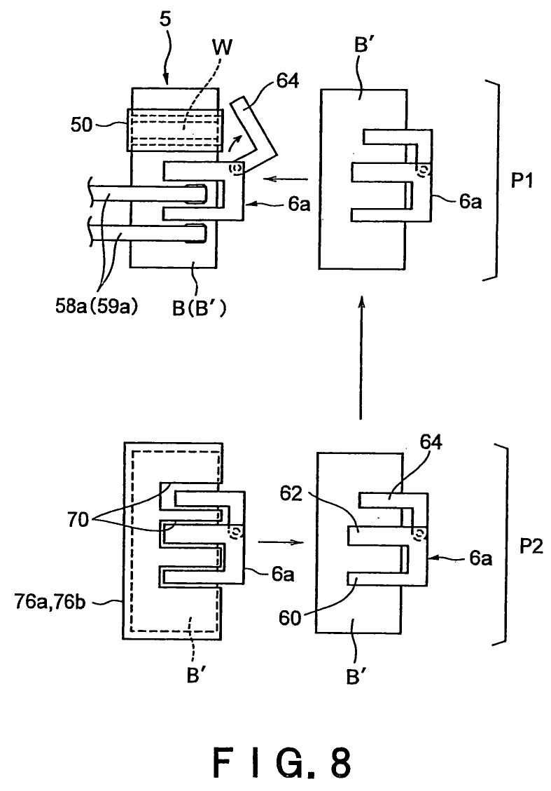

Further, the binding print unit 5 is provided with conveying belts 58, 59 for conveying the tied-up banknote bundle B to the upper portion of the ascending and descending path 2. An institution name stamp 5c for printing a name of the financial institution on the binding band W of the banknote bundle B and an unfit banknote stamp 5d for pressing an unfit banknote mark on the binding band W that binds the unfit banknotes, are disposed neighboring to the upper conveying belt 58 thereof. Note that swing retreat portions 58a, 59a (see FIG. 8) retreating to the outside when winding the binding band W are formed on the sides corresponding to nipping portions 50 of the conveying belts 58, 59.

It is to be noted that the carrying unit 4 is not limited to the unit employing the conveying belt 44 fitted with the pin 45 described above and may, if capable of moving the banknote bundle B in reciprocation along the carrying path C, take other constructions. Moreover, the bundle sorting dispensation unit 104 can be made independent as, e.g., a device that process only the already tied-up banknote bundle, and, in this case, it is possible to omit the binding print unit 5 and bundle carrying unit 6 in separation from the loose banknote deposit and dispensation unit 103. Moreover, the banknote bundle storage unit 3 may include, without being limited to the configuration having only one batch manner storage portion 3e, a plurality of batch manner bundle storage portions.

Herein, the bundle carrying unit 6 common to the bundle sorting dispensation unit 104 and to the loose banknote deposit and dispensation unit 103 will be described with reference to FIGS. 5 and 8. The bundle carrying unit 6 includes a pair of upper and lower nipping portions 6a that nip the loose banknote bundle B′, and a moving portion 6b (FIG. 5) that moves these nipping portions 6a. The moving portion 6b of the bundle carrying unit 6 moves the nipping portions 6a backward and forward in the front-and-rear directions, and moves the nipping portions 6a in the right-and-left directions between the bundle sorting dispensation unit 104 and the loose banknote deposit and dispensation unit 103. Each of the nipping portions 6a has, as illustrated in FIG. 8, three pieces of nipping pawls 60, 62, 64 extending forward. The right-end nipping pawl 64 thereof is enabled to swing-retreat backward in order to avoid interference with the nipping portions 50 of the binding print unit 5 in the bundle sorting dispensation unit 104.

### (2) Loose Banknote Deposit and Dispensation Unit 103

Next, a specific construction of the loose banknote deposit and dispensation unit 103 illustrated in FIG. 1 will be explained.

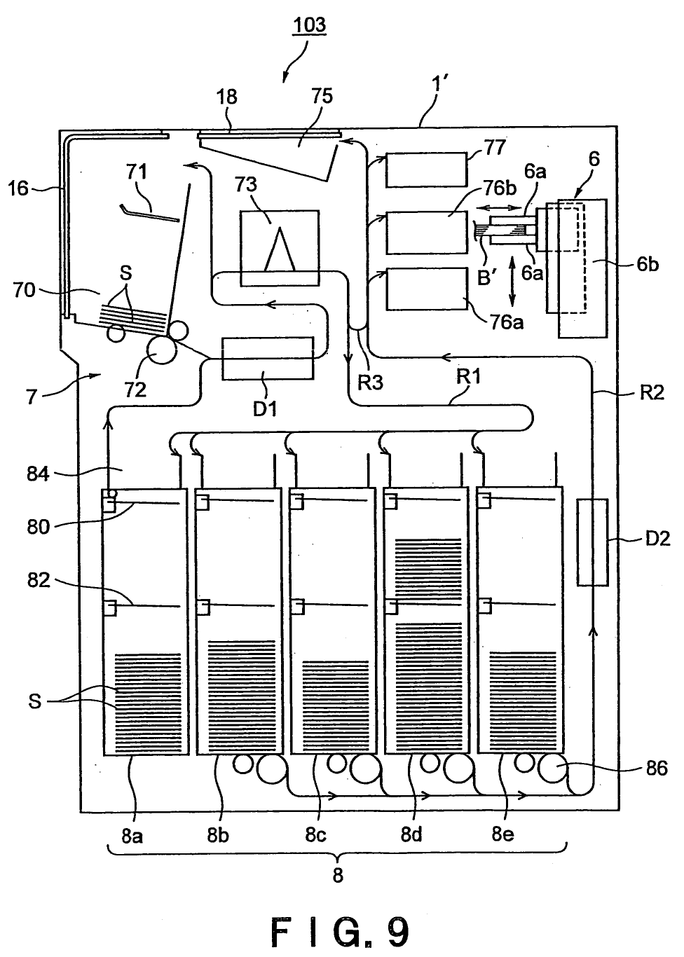

FIG. 9 schematically shows an internal structure of the loose banknote deposit and dispensation unit 103. Referring to FIG. 9, the loose banknote deposit and dispensation unit 103 includes a deposit and dispensation handling unit 7 and a banknote storage unit 8 provided at an upper part and a lower part within a housing 1′. The deposit and dispensation handling unit 7 has a deposit accumulating portion 70 and a reject accumulating portion 71 that correspond to the front upper part of the housing 1′, and a dispensation accumulating portion 75 corresponding to the upper face part of the housing 1′. The deposit accumulating portion 70 and the reject accumulating portion 71 are openable to the outside via a shutter opening and closing type of banknote input portion 16 (see FIGS. 1 and 4). Moreover, the dispensation accumulating portion 75 is also openable to the outside via a shutter opening and closing type of loose banknote dispensation port 18 (see FIG. 4).

On the other hand, the banknote storage unit 8 includes one batch manner storage portion 8a and four banknote storage portions 8b-8e, which are arranged in line in the front-and-rear directions. The batch manner storage portion 8a is of an attachable and detachable cassette type, wherein the banknotes in mixed denominations are batch manner taken in from the upper part thereof and fed out from the upper part. The four banknote storage portions 8b-8e are stored with the loose banknotes according to the denominations of the banknotes. Upper edge parts of the batch manner storage portion 8a and of the banknote storage portions 8b-8e are provided with a temporary holding portion 84, and lower edge parts of the banknote storage portions 8b-8e are respectively provided with feeding members 86. Further, movable separators 80, 82 are provided by two stages in interiors of the storage portions 8a-8e.

The number of the banknote storage portions is, though herein exemplified by “4”, normally set equal to or larger the number of the denominations of the banknotes actually issued. For example, in the case of the U.S.A., there are seven denominations such as 1 dollar, 2 dollars, 5 dollars, 10 dollars, 50 dollars and 100 dollars. In the case of China, there are six denominations such as 1 yuan, 2 yuan, 5 yuan, 10 yuan, 50 yuan and 100 yuan. Hence, the banknote storage portions, of which the number is set equal to or larger than the number of these denominations, are provided.

The banknotes having large quantities of circulations can be smoothly arranged in their deposits and dispensations by increasing, if extremely different in terms of the quantities of circulations of those denominations, the number of the banknote storage portions for the banknotes having the large quantities of circulations. For example, in the case of U.S. dollar, if the 1-dollar banknotes have an overwhelming quantity of circulation, one more banknote storage portion is prepared for 1 dollar, and totally 8 pieces of banknote storage portions can be provided. Furthermore, conversely if the quantities of circulations of 50 dollars and 100 dollars are small, the banknotes of these denominations are stored in mixture, thus enabling the two storage portions to be ensured for the 1-dollar banknotes while keeping the seven storage portions unchanged. The number of the storage portions can be further reduced based on this idea.

The deposit accumulating portion 70 provided corresponding to the banknote input portion 16 is provided with a feeding member 72, and a deposit carrying path R1 is formed between the feeding member 72 and the temporary holding portion 84 for the storage portions 8a-8e. A deposit discriminating portion D1 and a front side and back side inverting portion 73 are provided midways of the deposit carrying path R1. Further, a dispensation carrying path R2 is formed between the feeding members 86 and the dispensation accumulating portion 75. A dispensation discriminating portion D2 is provided midways of the dispensation carrying path R2, and branches off to two stackers 76a, 76b and to a dispensation eject box 77 anterior to the dispensation accumulating portion 75. The deposit carrying path R1 also branches off to the reject accumulating portion 71 between the deposit discriminating portion D1 and the front side and back side inverting portion 73. Moreover, a bypass carrying path R3 branching off from the deposit carrying path R1 downstream of the front side and back side inverting portion 73 gets confluent with the dispensation carrying path R2 upstream of the stacker 76a.

In the rear of the stackers 76a, 76b, the bundle carrying unit 6 is enabled to enter. The pair of nipping portions 6a of the bundle carrying unit 6 is also movable up and down with respect to the moving portion 6b, corresponding to the two pieces of upper and lower stackers 76a, 76b. Further, as illustrated in FIG. 8, three lines of notched portions 70 corresponding to the three nipping pawls 60, 62, 64 are formed in each of the stackers 76a, 76b. The nipping pawls 60, 62, 64 of the pair of nipping portions 6a of the bundle carrying unit 6 nip the loose banknote bundle B′ (via the notched portions 70) accumulated in the stackers 76a, 76b, and can thus pull the banknote bundle B′ backward.

Herein, an operation of the loose banknote deposit and dispensation unit 103 will be briefly described.

Loose banknotes S inserted into the deposit accumulating portion 70 via the banknote input portion 16 are fed on a sheet-by-sheet basis by the feeding member 72 and are carried along the deposit carrying path R1. These loose banknotes S are discriminated between their denominations by the deposit discriminating portion D1, and undiscriminable deposit reject banknotes are returned to the reject accumulating portion 71. Further, the banknote S opposite in its front side and back side to the predetermined direction is inverted by the front side and back side inverting portion 73 and sent to the downstream side. The loose banknotes S sent via the deposit carrying path R1 to the storage unit 8 are stored in the storage portions 8b-8e corresponding to the denominations thereof or in the batch manner storage portion 8a. On this occasion, the loose banknotes S are, after being accumulated in the temporary holding portion 84, stored in the storage portions 8b-8e or in the batch manner storage portion 8a by dint of the operations of the movable separators 80, 82.

On the other hand, the loose banknotes S taken out of the upper part of the batch manner storage portion 8a are carried to the deposit discriminating portion D1. The loose banknotes S fed out on the sheet-by-sheet basis by the lower feeding members 86 from the storage portions 8b-8e are carried along the dispensation carrying path R2. These loose banknotes S are discriminated between their denominations by the dispensation discriminating portion D2. The dispensation reject banknotes undiscriminable to the discriminating portions D1, D2 are accumulated in the dispensation reject box 77. The loose banknotes S other than those undiscriminable banknotes are accumulated in the dispensation accumulating portion 75 or in any one of the stackers 76a, 76b in accordance with the purpose. The dispensation banknotes accumulated in the dispensation accumulating portion 75 are taken out via the loose banknote dispensation port 18. Further, the loose banknotes S inserted into the deposit accumulating portion 70 can be also accumulated directly in the stackers 76a, 76b without via the storage unit 8 by making use of the bypass carrying path R3.

### (3) New Banknote Dispensation Unit 105

The new banknote connotes an unused banknote or a banknote close to the unused banknote. The new banknote dispensation unit 105 is a single-function machine that simply pays out the new banknotes prepared beforehand in the cassette in response to a request because of high demands for the new banknotes. The new banknote dispensation unit 105 links up with neither the loose banknote deposit and dispensation unit 103 nor the bundle sorting dispensation unit 104.

As illustrated in FIG. 1, only a new dispensation port 90 is formed in the front panel of the housing.

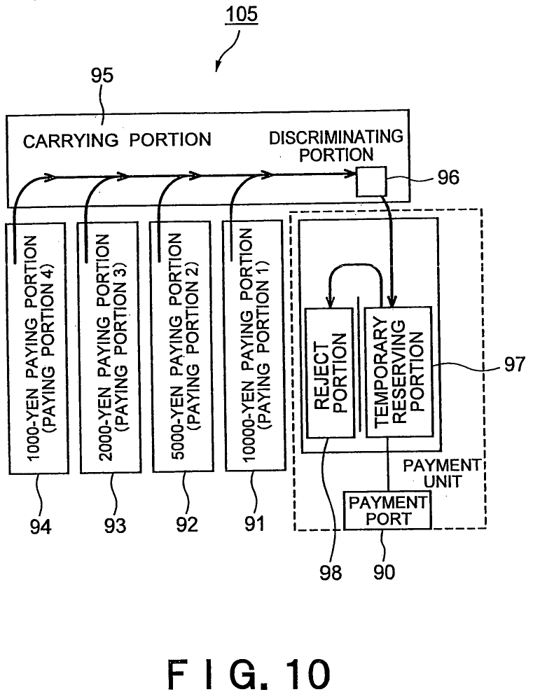

FIG. 10 is a schematic internal configuration diagram showing an internal configuration of the new banknote dispensation unit 105 and a flow of the banknotes.

Four cassette type dispensation units 91-94 previously stored with the new banknotes, wherein, for example, the first dispensation unit 91 is assigned to the banknotes of 10000 Yen, the second dispensation unit 92 is to the banknotes of 5000 Yen, the third dispensation unit 93 is to 2000 Yen, and the fourth dispensation unit 94 is to 1000 Yen.

Necessary sheets of banknotes are fed out of these dispensation units in response to an instruction, then carried by the carrying portion 95, and confirmed to be of the denomination instructed to be fed out but not to be the reject banknotes by a discriminating portion 96. All the carried banknotes, though reserved in the temporary holding portion 97, are paid out of the new banknote dispensation port if none of problems arise.

While on the other hand, if identified with the reject target banknotes, these banknotes reserved in the temporary holding portion are carried to the reject portion 98.

The types of the banknotes dealt with by the new banknote dispensation unit differ depending on the countries, and, as described above, the U.S.A. has the seven types of banknotes while China has the six types of banknotes. The types of the banknotes are, however, properly selected corresponding to the number of the dispensation units. The dispensation units can be assigned to the banknotes exhibiting a high frequency of usage and to the large denomination banknotes frequently used for special applications such as congratulations money. Further, as in the case of 1-dollar banknotes in the U.S.A. that has an overwhelmingly large quantity of circulation, a plurality of portions among the four dispensation units can be also assigned to 1-dollar banknotes.

The new banknote dispensation unit is neither indispensable for the system nor often installed as the case may be.

[Handling Contents]

Next, contents of a variety of processes by the banknote handling apparatus 100 according to the present embodiment will be explained in the way of roughly classifying the processes into the following processes (1)-(6). These processes are executed under control of a control unit of a computer etc on the basis of inputs etc from keyboards 113, 116 defined as operating units shown in FIG. 1, and the handling contents are displayed on display screens 111, 114 according to the necessity. Note that the descriptions of the respective processes will be made in a way that properly omits the explanations of the overlapped contents with those described earlier.

1. Process of Tying Up Loose Banknotes into Banknote Bundle and Ejecting Banknote Bundle outside

1.1 Sorting Process

A sorting process is that the loose banknotes S (out-of-machine banknotes) inserted into the deposit accumulating portion 70 of the loose banknote deposit and dispensation unit 103 are sorted into the banknote bundles B (eject banknote bundles), which are ejected by the bundle sorting dispensation unit 104 from the bundle out-of-machine ejection port 13.

To be specific, at first, in the loose banknote deposit and dispensation unit 103 illustrated in FIG. 3, the loose banknotes S inserted into the deposit accumulating portion 70 are fed out on the sheet-by-sheet basis by the feeding member 72 and carried along the deposit carrying path R1. The loose banknotes S (excluding the banknotes returned to the reject accumulating portion 71) passing through the deposit discriminating portion D1 and the front side and back side inverting portion 73, are accumulated in the stackers 76a, 76b via the dispensation carrying path R2 from the bypass carrying path R3. The loose banknote bundles B′ accumulated in the stackers 76a, 76b are carried to the bundle sorting dispensation unit 104 by the carrying unit 6.

The loose banknote bundles B′ carried to the bundle sorting dispensation unit 104 illustrated in FIG. 4 are fed into the binding print unit 5 by the carrying unit 6. The fed-in loose banknote bundles B′ are tied up with the binding band W and fed as the banknote bundle B to the ascending and descending path 2 by the conveying belts 58, 59. In the meanwhile, the binding band W is printed with a predetermined print by the printer 5b and is stamped with a financial institution name stamp 5C and further stamped, if necessary, with an unfit banknote stamp 5d.

The banknote bundle B fed out to the ascending and descending path 2 is placed on the ascending and descending stage 20 standing by in a receiving position h1. In the case of taking the banknote bundle B out of the bundle dispensation port 10, after the stage 20 has descended to a dispensation position h2, a shutter of the bundle dispensation port 10 opens, whereby the banknote bundle B is taken out of the bundle dispensation port 10. Further, in the case of ejecting the banknote bundle B from the bundle out-of-machine ejection port 13, the stage 20 descends to a lower position h3, and, after a shutter of the bundle out-of-machine ejection port 13 has opened, the inclined plate 22 above the stage 20 gets tilted with the front being lowered, whereby the banknote bundle B is ejected from the bundle out-of-machine ejection port 13.

1.2 Bundle Collecting Process

A bundle collecting process is that the loose banknotes S (intra-machine banknotes) stored in the storage unit 8 of the loose banknote deposit and dispensation unit 103 are ejected from the bundle out-of-machine ejection port 13 in order to collect the banknotes S as the banknote bundle B (eject banknote bundle) in the bundle sorting dispensation unit 104. Specifically, to start with, in the loose banknote deposit and dispensation unit 103 shown in FIG. 9, the loose banknotes S stored in any one of the storage portions 8b-8e are fed out on the sheet-by-sheet basis by the feeding members 86 and carried along the dispensation carrying route R2. The loose banknotes S (excluding those sent to the dispensation reject box 77) passing through the dispensation discriminating portion D2 are accumulated in the stackers 76a, 76b. The loose banknote bundles B′ accumulated in the stackers 76a, 76b are carried to the bundle sorting dispensation unit 104 by the carrying unit 6.

Then, the loose banknote bundles B′ carried to the bundle sorting dispensation unit 104 illustrated in FIG. 5 are, in the same way as in the case of 1.1 Sorting Process, fed out as the banknote bundles B to the ascending and descending path 2 and ejected from the bundle out-of-machine ejection port 13.

Note that a variety of operations can be applied to this bundle collection, and, for example, in the case of targeting the bundle at only the banknotes of 100 yuan in China, it is feasible to collect fractions of the banknote of 100 yuan, which are, i.e., the banknotes of 50 yuan, 20 yuan and 10 yuan, in the batch manner storage portion and to collect the banknotes of the denominations designated by a customer in the way of carrying these banknotes to the loose banknote dispensation port 18.

1.3 Bundle Dispensation Process

A bundle dispensation process is a process of dispensing, as the banknote bundle B (ejection banknote bundle), the loose banknotes S (intra-machine banknotes) by the bundle sorting dispensation unit 104, which are stored in the banknote storage unit 8 of the loose banknote deposit and dispensation unit 103 and taking the banknote bundle B out of the bundle dispensation port 10.

To be specific, at first, in the loose banknote deposit and dispensation unit 103 illustrated in FIG. 9, in the same way as in the case of 1.2 Bundle Collecting Process, the loose banknotes S stored in any one of the storage portions 8b-8e are accumulated in the stackers 76a, 76b and carried as the loose banknote bundles B′ to the bundle sorting dispensation unit 104 by the carrying unit 6.

Then, the loose banknote bundles B′ carried to the bundle sorting dispensation unit 104 illustrated in FIG. 5 are, in the same way as in the case of 1.1 Sorting Process, fed out as the banknote bundles B to the ascending and descending path 2 and taken out of the bundle dispensation port 10.

2. Process of Tying Up Loose Banknotes into Banknote Bundle and Storing Banknote Bundle

2.1 Bundle Loading Process

A bundle loading process is that the bundle sorting dispensation unit 104 stores the banknote bundle storage unit 3 with the loose banknotes S (out-of-machine banknotes), as the banknote bundle B (storage banknote bundle), inserted into the deposit accumulating portion 70 of the loose banknote deposit and dispensation unit 103.

Specifically, at the first onset, in the same way as in the case of 1.1 Sorting Process, the inserted loose banknotes S are tied up into the banknote bundle B. Namely, in the loose banknote deposit and dispensation unit 103, the loose banknotes S inserted into the deposit accumulating portion 70 are accumulated in the stackers 76a, 76b and carried as the loose banknote bundles B′ by the carrying unit 6 to the bundle sorting dispensation unit 104. Then, the loose banknote bundles B′ carried to the bundle sorting dispensation unit 104 shown in FIG. 5 are fed out as the banknote bundles B to the ascending and descending path 2 via the binding print unit 5.

The banknote bundles B fed out to the ascending and descending path 2 are, after being placed on the ascending and descending stage 20 standing by in the receiving position h1, lowered down to a height of the carrying path C. At this time, the opening and closing plates 34 for the ascending and descending path 2 are opened. Further, the swing retreat portion 4a of the carrying unit 4, which has retreated in preparation for the passage of the stage 20, swings to the carrying position and enters the ascending and descending path 2. Then, the banknote bundles B are carried along the carrying path C to the side of the banknote bundle storage unit 3 (the right side in FIG. 3) by driving the conveying belt 44 of the carrying unit 4. At this time, the bundle discriminating unit D discriminates between the denominations of the banknote bundles B.

When the banknote bundles B reach above the opening and closing plates 34 corresponding to the storage portions 3a-3e to which the banknote bundles B should be stored, the carrying belt 44 stops, then the opening and closing plates 34 open, and the banknote bundles B are stored in the storage portions 3a-3e. The specific storing operation is as described with reference to FIG. 5.

2.2 Intra-Machine Moving Loading and Auto Collecting Process

An intra-machine moving loading and auto collecting process is defined as an auto collecting function of, based on customer's setting, feeding the banknotes from the auto-designated banknote storage portion when the number of the banknotes accumulated in each of the respective storage portions 8b-8e becomes equal to or larger than a fixed accumulated banknote count, discriminating between the banknotes by the dispensation discriminating portion, tying up the banknotes into the bundles by the binding portion and storing the thus-obtained banknote bundles B in the banknote bundle storage portions, and also defined as an intra-machine moving loading function by which the customer himself or herself arbitrarily executes a process of tying up the banknotes in the banknote storage portions into the bundles by the bundle handling unit, corresponding to states of the respective storage portions and storing the banknote bundles in the banknote bundle storage unit 3.

Specifically, to begin with, in the loose banknote deposit and dispensation unit 103 illustrated in FIG. 9, the loose banknotes S in the storage portions 8b-8e, which have reached the banknote count designated by the customer, are, in the same way as in the case of 1.2 Bundle Collecting Process, accumulated in the stackers 76a, 76b and carried as the loose banknote bundles B′ by the carrying unit 6 to the bundle sorting dispensation unit 104.

Then, the loose banknote bundles B′ carried to the bundle sorting dispensation unit 104 shown in FIG. 5 are, in the same way as in the case of 2.1 Bundle Loading Process, fed out as the banknote bundles B to the ascending and descending path 2 and stored in the corresponding bundle storage portions 3a-3e.

Thus, it is possible not only to auto-collect the set number of banknotes in the storage unit but also to bundle the banknotes with the denomination designated corresponding to a state of the storage and store the banknote bundles in the bundle storage portion, wherein the handling itself is the same. In this case, the process is referred to as an intra-machine moving loading process, and a storage capacity of the storing unit can be ensured.

It is to be noted that if a plurality of temporary holding portions for bundling the banknotes is provided in the case of executing the process of tying up the loose banknotes in the process of tying up the first denomination of loose banknotes into the banknote bundles and ejecting these banknote bundles and in the process of tying up the second denomination of loose banknotes into the banknote bundles and storing these banknote bundles, the plurality of temporary holding portions is stored in distribution with both of the well-conditioned banknotes and the ill-conditioned banknotes on the basis of a discriminated result about the state of the banknotes by the discriminating portion, thereby enabling a distribution of the banknote states to be uniformized.

With this scheme, the banknote bundles containing only the well-conditioned banknotes or only the ill-conditioned banknotes can be prevented from being produced.

Moreover, the auto collecting function and the intra-machine moving loading function are carried out when reaching the customer's setting count in the description given above and may also be carried out when the respective storage portions get fully stored with the banknotes.

3. Process of Ejecting Stored Banknote Bundles Outside

3.1 Banknote Bundle Dispensation Process

A banknote bundle dispensation process is that the bundle sorting dispensation unit 104 pays the banknote bundles B (intra-machine banknote bundles) stored in the banknote bundle storage unit 3 and takes the banknote bundles B (as the eject banknote bundles) from the bundle dispensation port 10.

To be specific, the bundle sorting dispensation unit 104 illustrated in FIG. 5, at first, ejects the should-be-paid banknote bundles B to the carrying path C from the storage portions 3a-3e. A specific eject operation thereof is as described with reference to FIG. 7. The banknote bundles B ejected to the carrying path C are carried by the carrying unit 4 to the ascending and descending path 2 and placed on the ascending and descending stage 20 waiting there. Subsequently, the swing retreat portion 4a of the carrying unit 4 swings to the retreat position from the carrying position and thus retreats from within the ascending and descending path 2. Thereafter, the stage 20 rises to the dispensation position h2, and the shutter of the bundle dispensation port 10 opens, thereby taking the banknote bundles B out of the bundle dispensation port 10.

3.2 Banknote Bundle Out-of-Machine Ejection. Port Collecting Process

A banknote bundle out-of-machine ejection port collecting process is a process sin which the bundle sorting dispensation unit 104 ejects the banknote bundles B (intra-machine banknote bundles) (as eject banknote bundles) stored in the banknote bundle storage unit 3 from the bundle out-of-machine ejection port 13 in order to collect the banknote bundles B.

Specifically, in the bundle sorting dispensation unit 104 shown in FIG. 5, to begin with, in the same way as in the case of 3.1 Banknote Bundle Dispensation Process, the should-be-collected banknote bundles B ejected from the storage portions 3a-3e are carried to the ascending and descending stage 20. Next, the stage 20 descends to a lower position h3, and, after the shutter of the bundle out-of-machine ejection port 13 has opened, the inclined plate 22 above the stage 20 gets tilted with the front being lowered, whereby the banknote bundle B is ejected from the bundle out-of-machine ejection port 13.

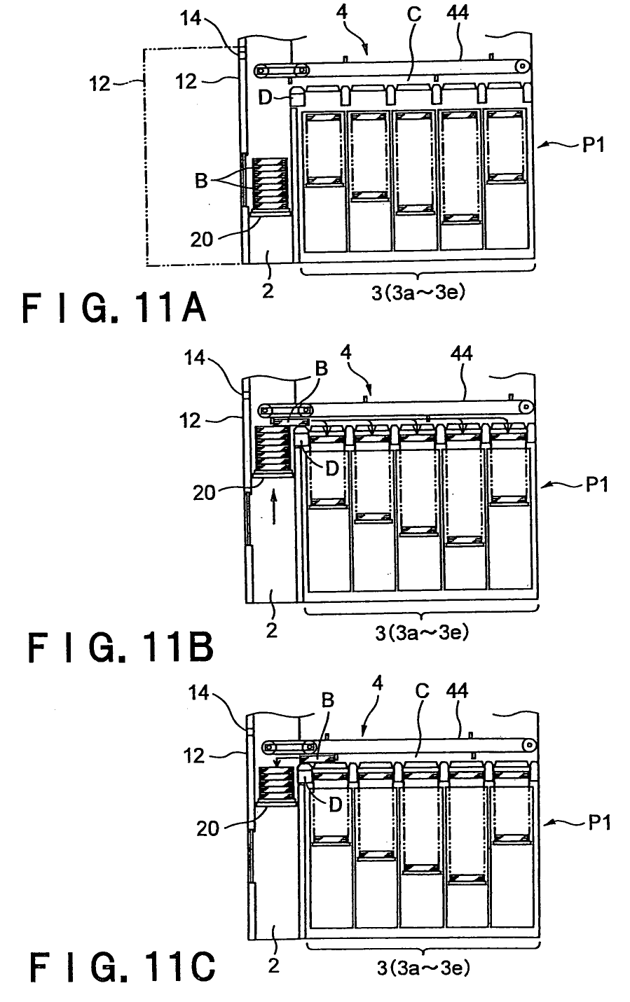

4. Out-of-Machine Bundle Loading Process (FIG. 11)

An out-of-machine bundle loading process is such a process that in the bundle sorting dispensation unit 104, the banknote bundles B (out-of-machine banknote bundles) inserted into the ascending and descending path 2 from the outside (via the opening and closing door 12) are automatically loaded (as storage banknote bundles) into the banknote bundle storage unit 3.

Specifically, when the operation unit 113 etc illustrated in FIG. 1 gives a predetermined loading instruction to the control unit, as shown in FIG. FIGS. 11A-11C, the process is executed in the following procedures. At first, the control unit automatically unlocks the locking device 14 of the opening and closing door 12 in the bundle sorting dispensation unit 104. The opening and closing door 12 opens, and, after the should-be-loaded banknote bundles B have been placed on the ascending and descending stage 20 waiting in the lower position h3 (FIG. 5) within the ascending and descending path 2, the opening and closing door 12 is closed (FIG. 11A).

Then, the control unit automatically locks the locking device 14 and starts auto-loading the inserted banknote bundles B (FIG. 11B). Namely, the stage 20 is raised on till the uppermost banknote bundle B reaches a height of the carrying path C, and this banknote bundle B is, in the same way as in the case of 2.1 Bundle Loading Process, loaded (stored) into the storage portions 3a-3e corresponding to the discriminated result of the bundle discriminating unit D. Thereafter, the respective banknote bundles B are similarly sequentially loaded while raising the stage 20 on a bundle-by-bundle basis.

In this case, the control unit sends the banknote bundles B undiscriminable to the bundle discriminating unit D when moved toward the storage unit 3 temporarily back toward the ascending and descending path 2 and then returns these banknote bundles B toward the storage unit 3 by use of the carrying unit 4, and, on this occasion, the banknote bundles B are again discriminated by the bundle discriminating unit D. This re-discriminating process may be done plural number of times according to the necessity.

Note that if the banknote bundles B moved by the carrying unit 4 toward the storage unit 3 are those disabled to be loaded into the storage unit 3, the control unit executes the following process. At the first onset, the carrying unit 4 returns the banknote bundles B onto the stage 20 of the ascending and descending path 2 (FIG. 11C). Then, a prompt of removing the banknote bundles B is displayed on the display screen 105a etc illustrated in FIG. 1.

This removal prompt display includes a display item enabled to specify a reason why the banknote bundles B can not be loaded into the storage unit 3. This reason is, it is considered, exemplified such as a reason (a) that the banknote bundles B are undiscriminable, a reason (b) that the bundle storage portions 3a-3e corresponding to the denomination of the banknote bundles B are already full of the banknote bundles, and a reason (c) that the bundle storage portions 3a-3e include none of setting of the storage portion corresponding to the denomination of the banknote bundles B.

These reasons are displayed in sentences or code numbers or symbols associated with these respective reasons on the display device.

The banknote bundles B can be automatically loaded into the storage unit 3 from outside by enabling the out-of-machine loading process to be executed. It is therefore possible to perform loading more accurately in a shorter period of time than in the case of manually loading the banknote bundles B. Further, the opening and closing door 12 can be automatically locked and unlocked by the locking device 14 when loading the banknote bundles B, and hence inconvenience caused when using a key can be obviated. Moreover, the stricter loading process can be executed by loading the banknote bundles B while the bundle discriminating unit D conducts the discriminating process. Further, the undiscriminable banknote bundles B are re-discriminated, thereby enabling a possibility of interrupting the auto loading process to be reduced by decreasing the number (occurrence frequency) of the banknote bundles B becoming undiscriminable to the end.

Moreover, in this out-of-machine loading process, if the banknote bundles B moved toward the storage unit 3 are those disabled to be loaded into the storage unit 3, the banknote bundles B are returned onto the stage 20 of the ascending and descending path 2, and the prompt for removing the banknote bundles B is displayed, thereby enabling the banknote bundles B to be immediately removed and the operation to be quickly get ready for resuming the loading process. On this occasion, the removal prompt display includes the display item enabled to specify the reason why the banknote bundles B can not be loaded into the storage unit 3, thereby making it possible to take a measure for preventing reoccurrence due to the same reason.

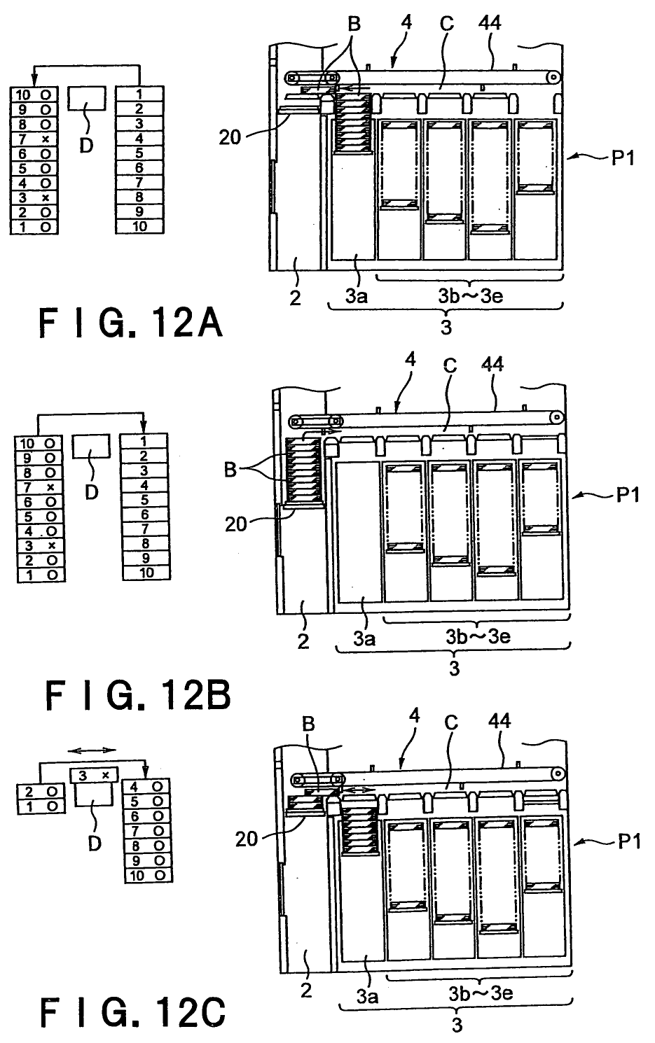

5. Auto Careful Inspection Process (FIG. 12)

An auto careful examination process is a process in which the bundle sorting dispensation unit 104 automatically carefully inspects the banknote bundles B (intra-machine banknote bundles) (an amount of balance is established by verifying the denominations, the number of banknote bundles, etc.) stored in the banknote bundle storage unit 3.

Specifically, when the operation unit 113 etc illustrated in FIG. 1 gives an instruction for a predetermined careful inspection to the control unit, as shown in FIGS. 12A-12C, the control unit executes a process in the following procedures. To begin with, the banknote bundles B are ejected bundle by bundle from the target bundle storage portion (which is herein the bundle storage portion 3a according to the denomination), then carried toward the ascending and descending path 2 and accumulated onto the ascending and descending stage 20. At this time, the bundle discriminating unit D performs the first discriminating process about each of the banknote bundles B (FIG. 12A).

Next, the banknote bundles B accumulated onto the stage 20 are returned to the previous bundle storage portion 3a, and in the meantime the bundle discriminating unit D conducts the second discriminating process about only the banknote bundles B that have proven undiscriminable in the first discriminating process (FIG. 12B). In the illustrative example, the second discriminating process is carried out about only the third and seventh banknote bundles B with a mark (x) representing being undiscriminable in the first discriminating process, among the first through tenth banknote bundles B.

At this time, the banknote bundle B (which is the third banknote bundle in the illustrative example) proving undiscriminable even in the second discriminating process is temporarily carried back toward the ascending and descending path 2 by the carrying unit 4 and then returned toward the storage unit 3, and in the meantime the bundle discriminating unit D performs the third discriminating process (FIG. 12C). If disabled to be discriminated in the third discriminating process, this leads to a prompt of taking action through an alarm on a display screen 111 or 114 illustrated in FIG. 11 or both of these screens. Note that the third and fourth discriminating processes can be also executed when the banknote bundle B reciprocates.

In the auto careful inspection process, the banknote bundles B are, after being moved to the ascending and descending path 2 from the storage unit 3, returned to the storage unit 3 from the ascending and descending path 2, and in the meantime the careful inspection process is executed about the banknote bundle B on the basis of the discriminated result by the bundle discriminating unit D. Hence, the auto careful inspection process can be done without emptying any one of the bundle storage portions 3a -3e. It is therefore feasible to reduce the time required for the auto careful inspection process by highly efficiently performing the careful inspection process.

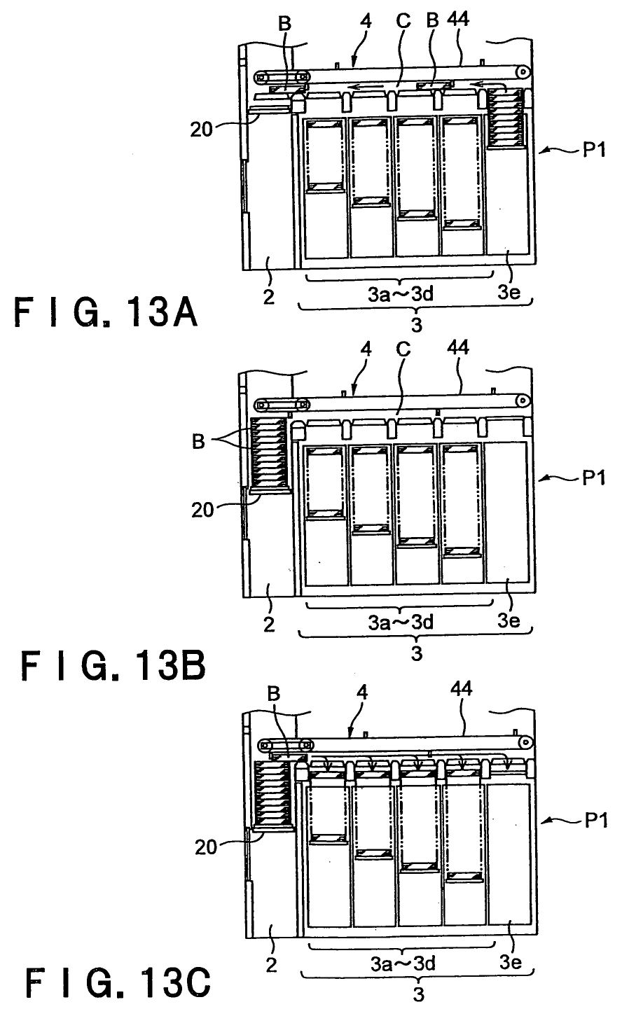

6. Auto Allocating Process (FIG. 13)

An auto allocating process is that the banknote bundles B stored in the denomination-mixed state in the batch manner storage portion 3e of the banknote bundle storage unit 3 of the bundle sorting dispensation unit 104, are automatically allocated to the bundle storage portions 3a-3e according to the corresponding denominations by use of the ascending and descending path 2.

To be specific, when the operation unit 113 etc illustrated in FIG. 1 gives a predetermined allocating instruction to the control unit, as shown in FIGS. 13A-13C, the control unit executes a process in the following procedures. At first, the banknote bundles B are ejected bundle by bundle from the batch manner storage portion 3e then carried toward the ascending and descending path 2 (FIG. 13A), and accumulated onto the ascending and descending stage 20 (FIG. 13B). After finishing moving all the banknote bundles B to the ascending and descending path 2, these banknote bundles B are returned on the bundle-by-bundle basis to the storage unit 3 and stored in the bundle storage portions 3a-3e according to the denominations corresponding to the discriminated results by the bundle discriminating unit D.

Note that this process may involve conducting the discriminating processes up to the third time similarly to the case of 5. Auto Careful Inspection Process, however, the discriminating process corresponding to second or third time among these processes may also be omitted.

In the auto careful inspection process, the banknote bundles B stored in the batch manner storage portion 3e are, after being moved to the ascending and descending path 2, allocated to the bundle storage portions 3a-3d according to the denominations from the ascending and descending path 2. Hence, the banknote bundles B to be allocated are, if corresponding to the already-fully-stored bundle storage portions 3a-3d according to the denominations or even if corresponding to none of the bundle storage portions 3a-3d according to the denominations, returned again to the batch manner storage portion 3e, whereby the allocating process can continue. Therefore, the process of allocating the banknote bundles to the bundle storage portions 3a-3d according to the denominations from the batch manner storage portion 3e can be smoothly executed.

Further, in (5) Auto Careful Inspection Process and (6) Auto allocating Process, the discriminating process up to the second time is executed during one reciprocation of the banknote bundles B between the storage unit 3 and the ascending and descending path 2, thereby enabling the auto careful inspection process and the auto allocating process to be executed at the higher efficiency. Moreover, the number (occurrence frequency) of the banknote bundles B becoming undiscriminable to the end can be reduced by further performing the third discriminating process according to the necessity.

B. Coin Handling Unit

As described above, the coin machine for depositing, dispensing, and sorting that executes the coin-oriented process is, as illustrated in FIG. 1, constructed of the-loose coin deposit and dispensation unit 102 and the packaged coin dispensation unit 101.

An upper part of the loose coin deposit and dispensation unit 102 is formed with a coin input portion 121. Normally, a shutter of the coin input portion 121 remains closed but gets opened when inserting the loose coins, and the hopper 201 gets exposed. A right lower side of the coin input portion 121 is formed with a reject port 122 into which the coins rejected when deposited are returned. Further, a calculation chute 123 into which the counted coins are ejected is formed at a central part of the front panel. The calculation chute 123 is used for an in-bag process of simply counting the coins and putting the coins into a bag. Moreover, a return box 124 receiving the loose coins to be returned is installed on the left side of the front panel.

On the other hand, the packaged coin dispensation unit 101 is provided at its upper part with a wrapped coin dispensation port 125. Provided at a middle stage thereof are a wrapped coin batch manner storage box 127 for storing batch manner the wrapped coins disabled to be stored in the storage portions according to the denominations and a loose coin dispensation box 129 for dispensing the loose coins. A wrapped coin ejection port 126 from which to eject the wrapped coins when in the collecting process is formed in a lower part of the front panel. An out-of-machine fraction box 128 into which the coins rejected when wrapped are thrown, is provide at the lower end part at the center.

The respective units will hereinafter be described.

(1) Loose Coin Deposit and Dispensation Unit 102

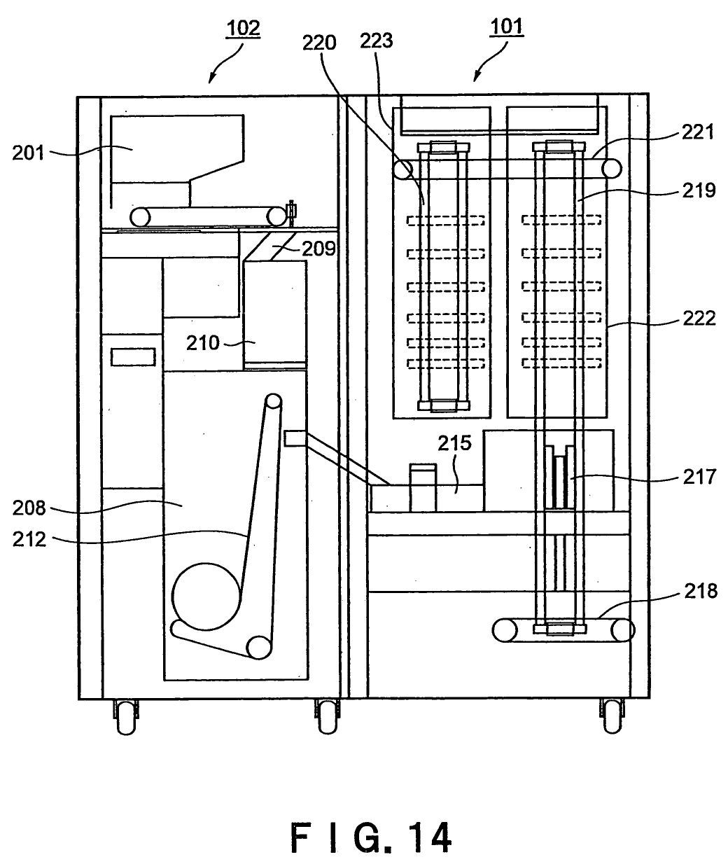

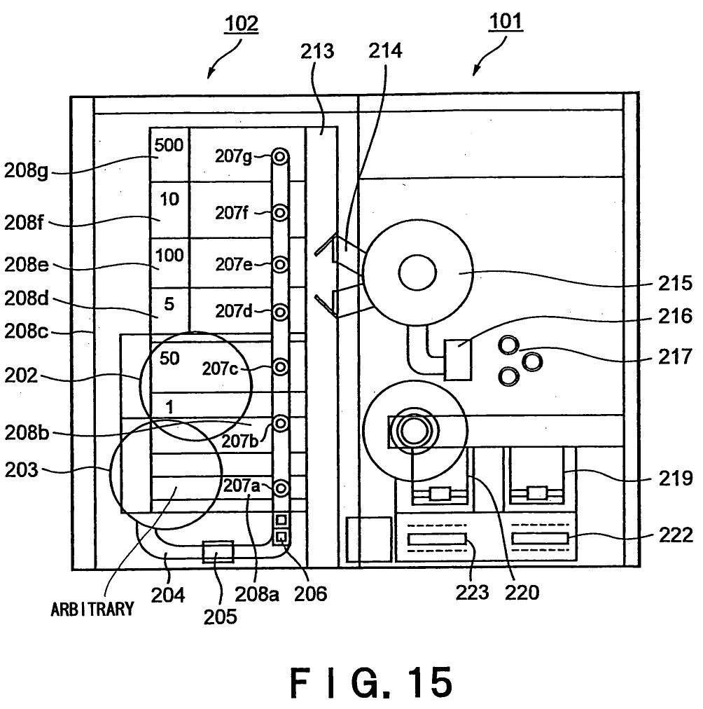

FIG. 14 is a vertical sectional view schematically illustrating an internal structure of the coin handling unit in FIG. 1. FIG. 15 is a plan view schematically showing a main configuration in FIG. 14.

The coins put into the coin input hopper 201 are sent one by one to a path 204 by a supply disc 202 existing on a bottom face of the hopper 201 and by a rotary disc 203 supplied with the coins by predetermined quantities through rotations of the supply disc 202.

The path 204 is provided with a discriminating portion 205 that specifies the type of the coin from a material, a size and a pattern on the surface. Provided in the path 204 ahead of the discriminating portion 205 are a reject selecting portion 206 for rejecting contaminated and unfit coins etc, and denomination selecting portions 207a through 207g that drop down the coins coming under the denominations concerned on the basis of diameters of apertures thereof. The coins passing through the denomination selecting portions 207a-207g are accumulated in temporary holding portions 210 provided for the respective denomination selecting portions via a chute 209 serving as a guide member. Bottoms of the temporary holding portions 210 are opened, whereby the coins are stored in coin storage portions 208a-208g. Herein, the symbol ‘a’ represents the arbitrary denomination selecting portion (and the arbitrary coin storage portion), while the symbols ‘b’ through ‘g’ represent the denomination selecting portions and the coin storage portions, which are provided, in the case of the coins circulated in Japan, in the sequence from the smallest diameter such as 1 yen, 50 yen, 5 yen, 100 yen, 10 yen and 500 yen. As for the arbitrary selecting portion (and the arbitrary coin storage portion), it is possible to set the overflow coins, the direct-wrapping-oriented coins and the bag-input-oriented coins of the denominations, which can not be stored in the temporary holding portions and the coin storage feeding portions.

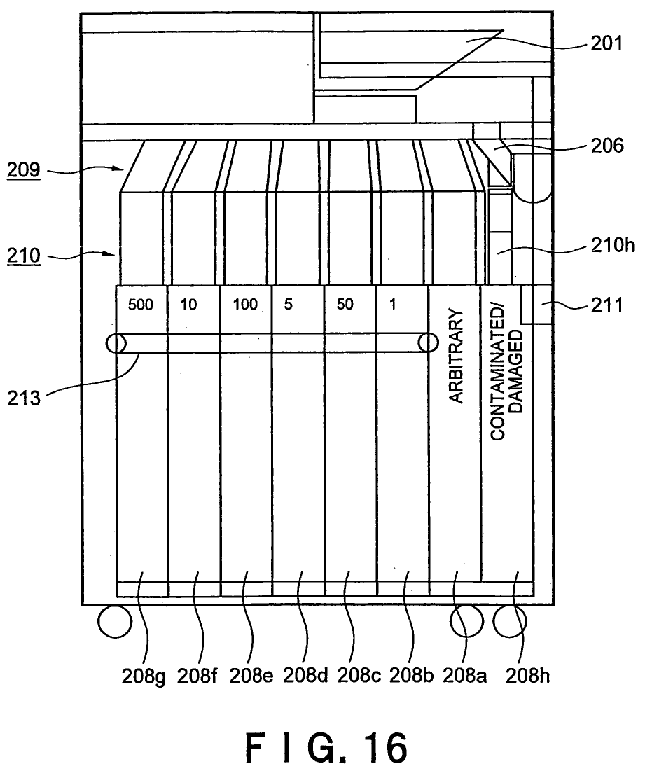

FIG. 16 is a side view showing a layout of these coin storage portions. As apparent from FIG. 16, a reject storage portion 208h is provided for the contaminated and unfit coins as well. It is to be noted that the coins rejected by the reject selecting portion 206 can be output into the reject port 122 by switching over the route.

The coins stored in the respective coin storage portions 208 are taken out by a takeout mechanism 212 using the belt shown in FIG. 13, and are placed on a belt carrying path 213 movable in forward and backward directions.

(2) Wrapped Coin Dispensation Unit 101

The coins on the belt carrying path 213 of the loose coin deposit and dispensation unit 102 are guided onto a rotary disc 215 for wrapping the coins by a take-in mechanism 214 having two guides and then accumulated in an accumulating portion 216 through rotations of the rotary disc 215. After a predetermined number of coins have been accumulated in the accumulating portion 216, the coins are wrapped by a coin wrapping portion 217. The coin wrapping portion 217 is, as known well, constructed such that a predetermined number of stacked coins are pushed up to a predetermined wrapping position by a support rod protruding upward and rotated by three pieces of wrapping rollers while nipping peripheral surfaces of the stacked coins, then a sheet of wrapping paper (not illustrated) is wound around peripheries of the stacked coins by wrapping the wrapping paper along the peripheral surfaces of the stacked coins, and the edge of the wrapping paper is caulked to the edge surfaces of the stacked coins, thus obtaining the wrapped coins (a bar of coins).

The wrapped coins are carried by a belt carrying mechanism 218 to a first elevator 219. The first elevator 219 rises to carry the wrapped coins, hereby the wrapped coins are stored in a proper storage portion of first wrapped coin storage portions 222 provided upward. Second wrapped coin storage portions 223 are provided in parallel with the first wrapped coin storage portions 222. Similarly, a second elevator 220 is provided for moving the wrapped coins up and down. Further, a belt carrying mechanism 221 is provided for moving the wrapped coins in the horizontal direction between the first elevator 219 and the second elevator 220, thereby increasing a storage capacity with a narrow space. Moreover, the wrapped coins are controlled to be stored alternately in the wrapped coin storage portions 222, 223 by use of the belt carrying mechanism 221 or stored in the wrapped coin storage portions having a less storage quantity, thus enabling the wrapped coins to be stored evenly in distribution.

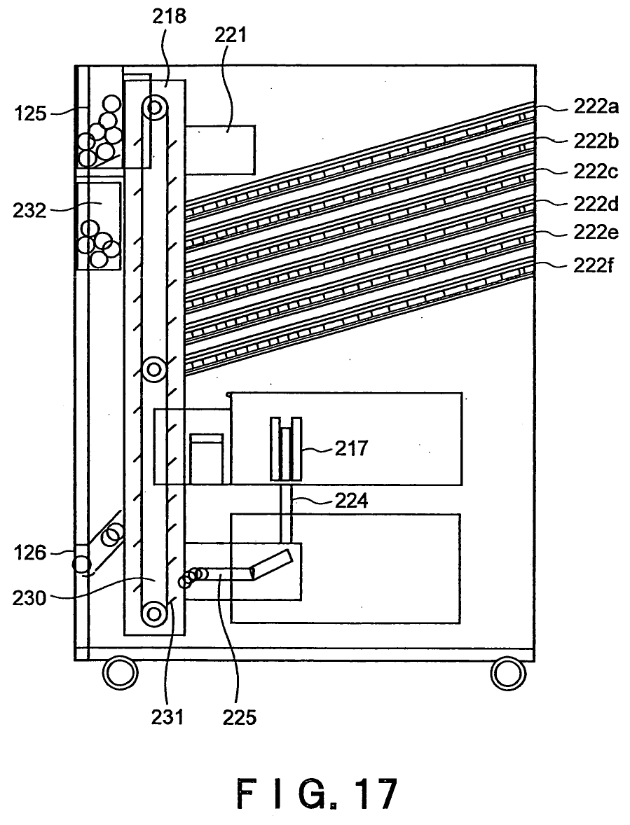

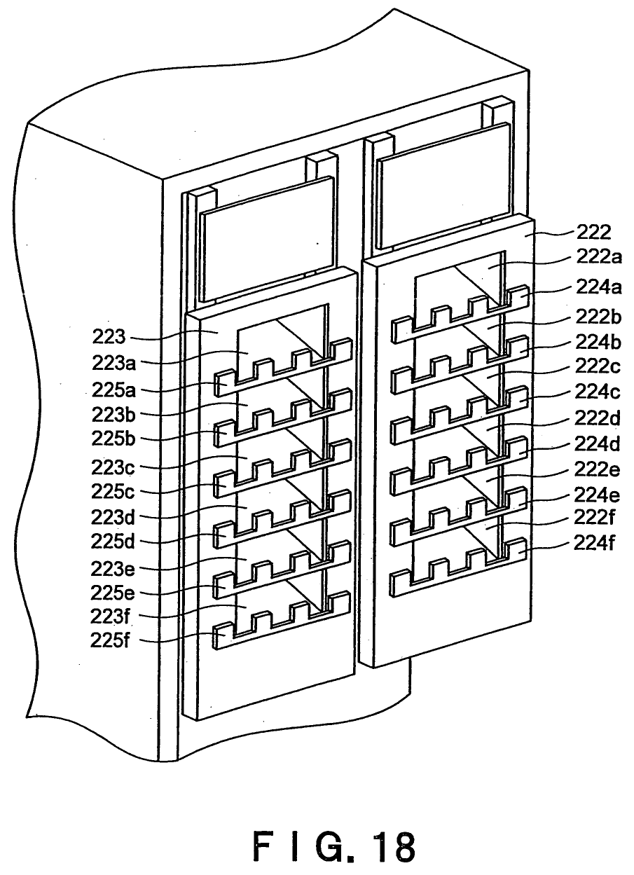

FIG. 17 is a side view of the main configuration related to storing the wrapped coins, as viewed from a right side surface in FIG. 14. FIG. 18 is a perspective view showing one example of the wrapped coin storage portions 222, 223. Herein, each of the wrapped coin storage portions 222, 223 has six sections (bar-of-wrapped coins trays) attached with suffixes ‘a’-‘f’.

As described above, the coins are wrapped by the coin wrapping portion 217, however, the post-wrapping coins are set vertical in a longitudinal direction, i.e., in a stacking direction and therefore hard to deal with. Hence, the wrapped coins are dropped by use of the first chute 224, at which time the longitudinal direction of the wrapped coins is invariably parallel with the front surface of the main body, and the second chute 225 is formed so that the wrapped coins get rolling to the front of the elevator while changing the longitudinal direction to the horizontal direction.

A belt 230 partly constituting the elevator 218 is driven by a motor (not illustrated) and stretched between upper and lower rotatable pulleys. Fins 231 having an angle directed upward and building up a placing portion are embedded at fixed intervals in the surface of the belt 230. The wrapped coins are mounted one by one on the fins and raised while being driven by the elevator.

The wrapped coin storage portions 222, 223 provided at the upper part include storage-oriented inclined plates 222a-222f, 223a-223f installed at substantially the same angle as that of each fin 231. Stopper plates 224a-224f, 225a-225f having notched portions are provided on the inlet side thereof. For moving the wrapped coins to the inclined plates 222a-222f from the fins 231 of the elevator, the wrapped coins may be moved onto the inclined plates over the stopper plates from the fin portion by use of a take-in and take-out member having such a shape as to enable its front end to pass through the notched portion.

Note that the wrapped coins are moved onto the fins of the elevator by slightly raising the take-in and take-out member inserted into the notched portion when taking the wrapped coins out of the wrapped coin storage portion as when outputting the wrapped coins. Then, the wrapped coins get gravity-dropped when passing by the maximum point, and hence the wrapped coin dispensation port 125 (see FIG. 16) is provided at this position. It is therefore possible to take the wrapped coins from the wrapped coin dispensation port 125.

Moreover, a vertically-movable box 232 into which the wrapped coins are put, whereby the wrapped coins to be output can be stored therein. This output box can be cassettized, and can be also exchanged by opening the front door and taking out the box as the necessity may arise. Further, an output port 126 (see FIG. 1) via which to output the wrapped coins outside the machine on a single coin-bar basis according to the necessity, is provided at the lower part of the front panel.

Next, handling contents, based on the configurations described above, in the coin handling units 103, 104 according to the present embodiment will be explained with reference to FIGS. 14-18. These processes are executed based on the inputs from the operation unit 113 illustrated in FIG. 1 under the control of the control unit, and the handling contents are displayed on the display screen 111 as the necessity may arise.

7. Process Related to Input of Loose Coins into Loose Coin Input Port

7.1 Loose Coin Deposit Process

When setting the loose coins into the hopper 201 shown in FIG. 14 by opening the shutter 121 shown in FIG. 1, the coins are sent as the supply disc 202 rotates and fed out one by one to the coin path 204 and then carried along this coin path. The discriminating portion 205 provided midways of the coin path 204 discriminates between the coins about the fit and unfit states, the denominations, etc. The reject selecting portion 206 for rejecting the contaminated and unfit coins etc rejects the contaminated and unfit coins, and the rejected coins are, after being temporarily reserved in a temporary holding portion 210h, discharged from the reject port 122. In this case, such a scheme can be also set that the coins are accumulated in a coin storage portion 208h under the temporary holding portion 210h by switching over the route. Moreover, the fit (normal) coins passing through the denomination selecting portions 207a-207g are accumulated in the temporary holding portions 210 provided for the respective denomination selecting portions via the chute 209 serving as the guide member. The coins are, when the bottoms of these temporary holding portions are opened, stored in the coin storage portions 208a-208g.

7.2 Loose Coin Loading Process

A loose coin loading process, which is similar to 7.1 Loose Coin Deposit Process, is that the fit (normal) coins are likewise stored in the coin storage portions via the denomination selecting portions. If judged to be the unfit coins by the reject selecting portion 206, however, the unfit coins are discharged directly into the reject port 122 without via the temporary holding portion 210h by switching over the chute direction.

7.3 Coin Wrapping Loading Process

A coin wrapping loading process is, similarly to 7.1 Loose Coin Deposit Process, that the loose coins set in the hopper 201 are taken in, then discriminated by the coin discriminating portion 205 and placed on the belt carrying path 213 movable in the forward and backward directions. The coins on the belt carrying path 213 are guided by the take-in mechanism 214 having the two guides onto the rotary disc 215 for wrapping the coins. With the rotations of the rotary disc 215, the coins are accumulated in the accumulating portion 216. A predetermined number of coins are, after being accumulated in the accumulating portion 216, wrapped by use of the three wrapping rollers in the coin wrapping portion 217. Then, the wrapped coins are sent to the first elevator 219 by the belt carrying mechanism 218. The wrapped coins are raised and thus carried by the first elevator 219 and are, just over the maximum point, stored in the wrapped coin batch manner storage box 232.

7.4 Sorting Process

In 7.1 Loose Coin Deposit Process, the coins placed on the belt carrying path 213 movable in the forward and backward directions are guided onto the rotary disc 215 for wrapping the coins by the take-in mechanism 214 having the two guides and accumulated in the accumulating unit 216 through the rotations of the rotary disc 215. The predetermined number of coins are, after being accumulated in the accumulating unit 216, wrapped by use of the three wrapping rollers in the coin wrapping portion 217.

The wrapped coins are sent to the first elevator 219 by the belt carrying mechanism 218. Then, the wrapped coins are raised and thus carried by the first elevator 219 and are, just over the maximum point, discharged to the wrapped coin dispensation port 126, thus enabling the wrapped coins to be taken out.

7.5 In-Bag Process

An in-bag process is, similarly to 7.1 Loose Coin Deposit Process, that the loose coins set in the hopper 201 are taken in, then counted and output from a calculation chute 123 provided at the central part of the front panel. This process intends to verify the number of coins already proven to be the fit (normal) coins, however, the discriminating process is conducted for eliminating the contaminated and unfit coins. The contamination and unfitetection can involve setting [ON] and [OFF]. In the case of setting [ON], based on the discriminated result, the contaminated and unfit coins are rejected, while the fit coins (normal coins) are put in a storage bag set in the calculation chute 123, whereby the in-bag coins convenient for portability within the financial institution can be obtained (the in-bag process can be executed).

On the other hand, in the case setting [OFF], both of the fit coins and the contaminated and unfit coins are taken as the in-bag coins by setting the storage bags in the calculation chute 123.

8. Process Related to Feed-Out from Loose Coin Storage Portion

8.1 Loose Coin Dispensation Process

When the control unit gives a loose coin dispensing instruction, a necessary number of coins of the designated denomination, which are stored in the coin storage portions 208a-208g, are taken out by the takeout mechanism 212, and discharged to the loose coin dispensation box 129 illustrated in FIG. 1 via the carrying path (not illustrated), carrying box, etc, and the desired coins are thus obtained from the loose coin dispensation box 129.

8.2 Loose Coin Auto Collecting Process and Intra-Machine Moving Loading Process

A loose coin auto collecting process is a process executed when any one of the coin storage portions 208a-208g reaches the coin count set by the customer and when a residual quantity in the wrapped coin storage portion becomes small. The loose coin auto collecting process is a process of feeding the loose coins from the coin storage portion, then wrapping the loose coins by the coin wrapping portion 217, carrying the wrapped coins by use of the elevator 219 etc, and storing the wrapped coins in an output-oriented cassette 222. The cassette 222 is taken out by pulling out the front panel of a wrapped coin processor 102.

This process can be performed, without being limited to when reaching the coin count set by the customer, similarly based on the instruction. In this case, the coins are simply moved within the machine, which is therefore referred to as an intra-machine moving loading process.

Moreover, the auto collection can be also conducted when the coin storage portions get full of the coins irrespective of the setting.

8.3 Loose Coin Pack Collecting Process

A loose coin pack collecting process is the same as 8.2 Loose Coin Auto Collecting Process and Intra-Machine Moving Loading Process in terms of such a point that the loose coins are fed out of any designated storage portion among the coin storage portions 208a-208g, then wrapped by the coin wrapping portion 217, and the wrapped coins are carried by use of the elevator 219 etc. The loose coin pack collecting process is, however, different from 8.2 Process in terms of a point that the wrapped coins are ejected from the wrapped coin ejection port 126 via an out-of-machine chute.

8.4 Loose Coin Denomination-Based Storage Portion Collecting Process

A loose coin denomination-based storage portion collecting process is a process, wherein the loose coins are fed out of the coin storage portion of the designated denomination among the coin storage portions 208a-208g and discharge into the dispensation reject box.

9. Process Related to Feed-Out from Wrapped Coin Batch Manner Storage Box

9.1 Wrapped Coin Dispensation Process

A wrapped coin dispensation process is a process of feeding out a designated number of wrapped coins of a designated denomination from the wrapped coin storage portions 222, 223 and discharging the wrapped coins into the wrapped coin dispensation port 125.

9.2 Wrapped coin Ejection Port Collecting Process

A wrapped coin ejection port collecting process is a process of feeding out a designated number of wrapped coins of a designated denomination from the wrapped coin storage portions 222, 223 and ejecting the wrapped coins outside the machine from the wrapped coin ejection port 126.

9.3 Wrapped coin Dispensation Port Collecting Process

A wrapped coin dispensation port collecting process is a process of feeding out a designated number of wrapped coins of a designated denomination from the wrapped coin storage portions 222, 223 and discharging the wrapped coins into the wrapped coin dispensation port 125.

In addition to the processes described above, the banknote and coin handling system according to the present invention enables the manual direct takeout. Namely, the necessary doors are formed to enable the batch manner takeout from the batch manner storage portion, the batch manner takeout from the bundled banknote cassette, the batch manner takeout from the wrapped coin batch manner storage box and also the single takeout of the wrapped coins.

The embodiment discussed above has exemplified nothing but one example of each of the configurations of the respective portions, and the scope of the present invention embraces changes, modifications, replacements with substituting units, and enlargement or contraction, which are carried out in the range of normal knowledge of those skilled in the art.

For example, normally the coin storage portions are provided by the number corresponding to the number of types of the circulated coins, however, this scheme is not necessarily attained. Namely, if a sufficient number of coin storage portions can not be provided in terms of the size, a configuration is that the coins may be stored in the mixed state of the denominations and may be selected according to the denominations when dispensing and wrapping the coins. Moreover, the two or more coin storage portions can be allocated to the coins of which the usage frequency is high.

As for the processes about the coins described above, the storage portions can be provided corresponding to the denominations of the coins circulating in the respective countries, e.g., the six existing denominations such as 1 dollar, 50 cents, 25 cents, 10 cents, 5 cents and 1 cent in the U.S.A. and the six existing denominations such as 1 yuan, 5 jao, 1 jao, 5 fen, 2 fen and 1 fen in China. As a matter of fact, however, the three denominations of 5 fen, 2 fen and 1 fen each have a small quantity of circulation in China, and hence these currencies may not wrapped according to the denominations but may be received in a loose state.

The banknote and coin handling system described above is one example, and, the banknote and coin handling system according to the present invention may be any type of system if having the configuration of combining together the apparatus dealing with the banknotes and the apparatus dealing with the coins. For example, the right-and-left positions of the loose coin deposit and dispensation unit 102 and the wrapped coin dispensation unit 101 may be reversed.

Further, the banknote and coin handling system described above has, basically, the combination of the four units such as the loose banknote deposit and dispensation unit and the bundle sorting dispensation unit that execute the process related to the banknotes, and the loose coin deposit and dispensation unit and the wrapped coin dispensation unit that execute the process related to the coins. A banknote machine for depositing, dispensing, and sorting having the same function related to the banknotes may be combined with a coin machine for depositing, dispensing, and sorting, or apparatuses having further sub-functions may also be combined.

### First Embodiment

Next, a first embodiment of the present invention will be discussed. The first embodiment of the present invention will exemplify a verification system for a banknote-and-coin handling system, which performs verifying without any previous notice based on an instruction etc given from a monitor server.

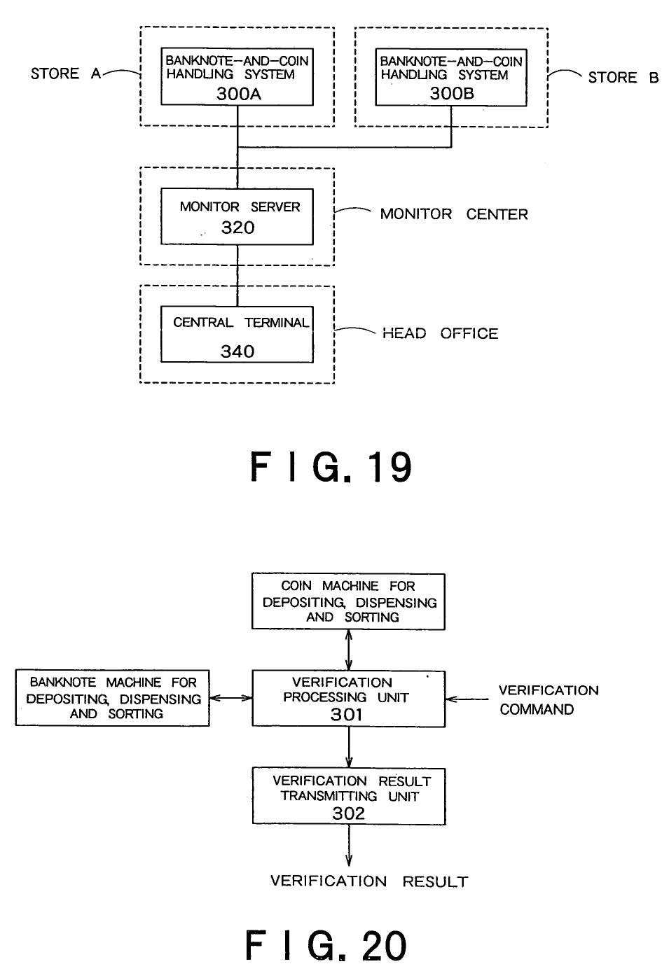

FIG. 19 is a block diagram showing architecture of the verification system for the banknote-and-coin handling system according to the first embodiment of the present invention.

The verification system for the banknote-and-coin handling system includes a plurality of banknote-and-coin handling systems 300A, 300B provided at stores A, B, a monitor server 320 provided at a monitor center and a central terminal 340 provided at a head office. The monitor server 320 is connected to the banknote-and-coin handling systems 300A, 300B and to the central terminal 340.

FIG. 20 is a block diagram showing a configuration of the banknote-and-coin handling system 300 according to the first embodiment of the present invention.

The banknote-and-coin handling system 300 includes a verification processing unit 301, a verification result transmitting unit 302, a coin machine for depositing, dispensing, and sorting and a banknote machine for depositing, dispensing, and sorting.

The verification processing unit 301 executes a verification process based on a verification command transmitted from the monitor server 320.

The verification result transmitting unit 302 transmits a verification result of the verification processing unit 301 to the monitor server 320. Note that the verification result transmitting unit 302 may transmit the verification result by mail to the monitor server 320 and may also deliver the mail to a mobile communication terminal (e.g., a mobile phone).

The coin machine for depositing, dispensing, and sorting and the banknote machine for depositing, dispensing, and sorting are configured as described above.

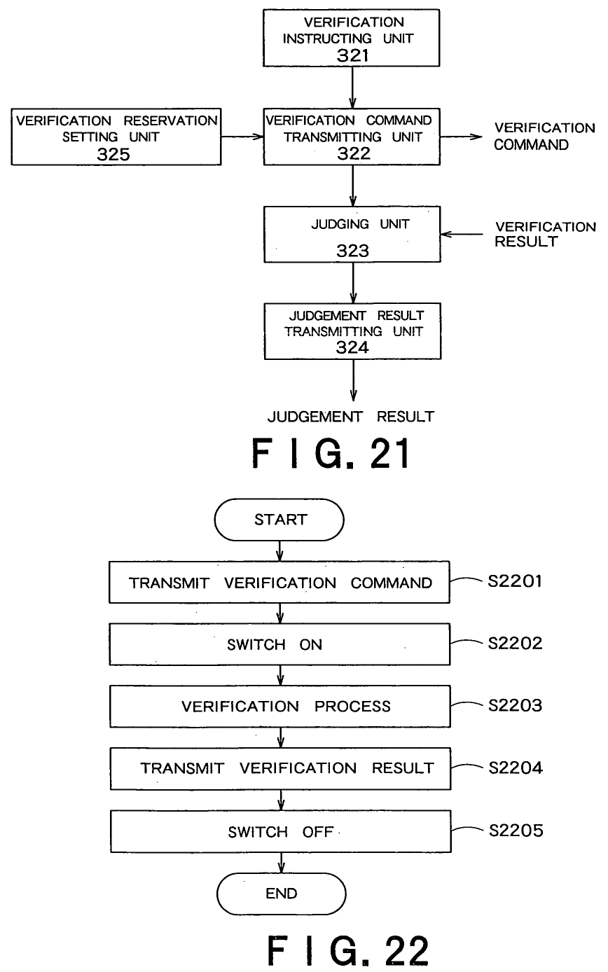

FIG. 21 is a block diagram showing a configuration of the monitor server 320 according to the first embodiment of the present invention.

The monitor server 320 includes a verification instructing unit 321, a verification command transmitting unit 322, a judging unit 323, a judgment result transmitting unit 324 and a verification reservation setting unit 325.

A verification command is inputted to the verification command transmitting unit 322 from the verification instructing unit 321 that gives a verification instruction. The verification command transmitting unit 322 transmits the verification command to the banknote-and-coin handling system 300. A verification result given from the banknote-and-coin handling system 300 is inputted to the judging unit 323. A judgment result made by the judging unit 323 is transmitted to the central terminal 340 from the judgment result transmitting unit 324. The verification reservation setting unit 325 is provided for setting verification reservation date and time. When the verification reservation setting unit 325 sets the reservation date and time, the set date and time is transmitted to the banknote-and-coin handling system 300 from the verification command transmitting unit 322.

FIG. 22 is a flowchart showing a handling procedure of the verification system for the banknote-and-coin handling system 300 according to the first embodiment of the present invention. Note that according to the first embodiment, the banknote-and-coin handling system 300 performs the same processes as the banknote-and-coin handling system 100 does in an operation time zone. Power sources of the coin machine for depositing, dispensing, and sorting and the banknote machine for depositing, dispensing, and sorting are switched OFF in the night time after summing up the accounts on a day-by-day basis or on holidays, however, the power sources of the verification handling unit 301 and the verification result transmitting unit 302 remain switched ON.

At first, the verification command transmitting unit 322 of the monitor server 320 transmits the verification command to the banknote-and-coin handling system 300 in the night time or on the holiday (S2201).

Then, the verification handling unit 301 of the banknote-and-coin handling system 300 switches ON the power sources of the coin machine for depositing, dispensing, and sorting and the banknote machine for depositing, dispensing, and sorting (S2202).

Then, the verification handling unit 301 executes the verification process (S2203). The verification process is carried out in a way that sequentially feeds out on the one-by-one basis the loose coins of the respective denominations that are stored in the coin storage portions 208 and the loose banknotes of the denominations that are stored in the banknote storage portions 8, counts these moneys through the discriminating portion 205 and the dispensation discriminating portion D2, and stores the moneys again in the coin storage portions 208 and the banknote storage portions 8.

Then, the verification result transmitting unit 302 of the banknote-and-coin handling system 300 transmits the verification result by the verification handling unit 301 to the judging unit 323 of the monitor server 320 (S2204). The verification result contains termination information, balance data and a count result.

Then, the verification handling unit 301 switches OFF the power sources of the coin machine for depositing, dispensing, and sorting and the banknote machine for depositing, dispensing, and sorting (S2205).

The processing by the verification system of the banknote-and-coin handling system 300 according to the first embodiment of the present invention terminates after S2205.

By the way, each of the coin machine for depositing, dispensing, and sorting and the banknote machine for depositing, dispensing, and sorting includes a memory that retains count data of the moneys which should exist in each of the coin storage portion 208, the banknote storage portion 8, the reject port 122 and the reject accumulating portion 71. The reject port 122 and the reject accumulating portion 71 are stored with ill-conveyed moneys of which the number is disabled from being specified due to chain-conveyance, dual conveyance, damaged moneys, etc and with the moneys excluded from the designated denominations. If the moneys that are easy to cause the ill-conveyance are again conveyed for verifying, an error (a jam in conveyance) might get easy to occur. Therefore, these moneys are not counted in the first embodiment of the present invention. The moneys stored in the reject port 122 and the reject accumulating portion 71 are counted according to the denominations to the greatest possible degree, and the verification process is conducted by use of a result of this counting without re-counting the moneys in the reject port 122 and the reject accumulating portion 71.

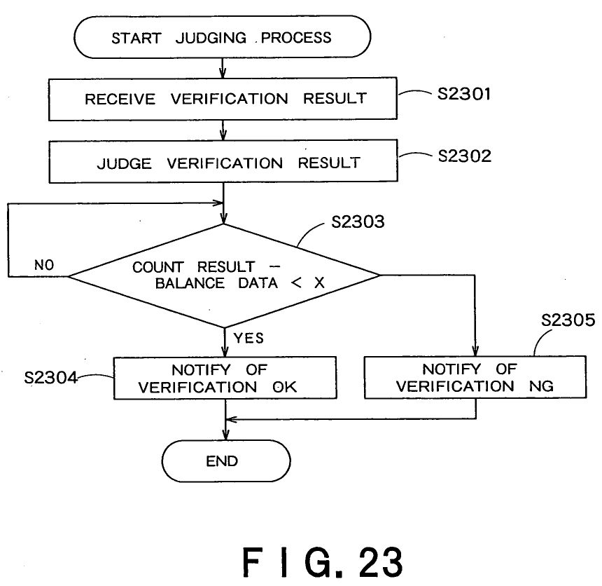

FIG. 23 is a flowchart showing a handling procedure of a judging process according to the first embodiment of the present invention.

At first, the judging unit 323 of the monitor server 320 receives the verification result (S2301).

Then, the judging unit 323 judges the verification result (S2302).

If a difference between the count result and the balance data is within a fixed range X (if within, e.g., 30% of an estimated count value in each of the reject port 122 and the reject accumulating portion 71) (S2303-YES), the judgment result transmitting unit 324 of the monitor server 320 transmits notification showing “Verification OK” to the central terminal 340 (S2304).

Whereas if the difference between the count result and the balance data is not within the fixed range X (S2303-NO), the judgment result transmitting unit 324 of the monitor server 320 transmits the notification showing “Verification NG” to the central terminal 340 (S2305).

The judging process according to the first embodiment of the present invention terminates after S2301 and S2305.

Note that according to the first embodiment of the present invention, if the moneys in the reject port 122 and the reject accumulating portion 71 are not counted again, some error might be taken into account. Hence, the verification result is judged to be OK if within the predetermined rate (e.g., ±30%) of the count value of each of the reject port 122 and the reject accumulating portion 71 but judged to be NG if equal to or larger than the predetermined rate. Another scheme is that the operator manually and visually checks the moneys in the reject port 122 and the reject accumulating portion 71, then deposits the countable moneys into the banknote-and-coin handling system 300, and inputs uncountable moneys by key-inputting from the keyboards 113, 116. At a point of time when completely counting the moneys in the reject port 122 and the reject accumulating portion 71, the monitor server 320 is notified of a final verification result. In this case also, a large proportion of the verification operations of the banknote-and-coin handling system 300 have been automatically finalized in the night time, and therefore the operator is substantially disabled from falsifying through a dishonest act.

Next, a first modified example of the first embodiment of the present invention will be described. Note that the same descriptions as those in the first embodiment of the present invention are omitted.

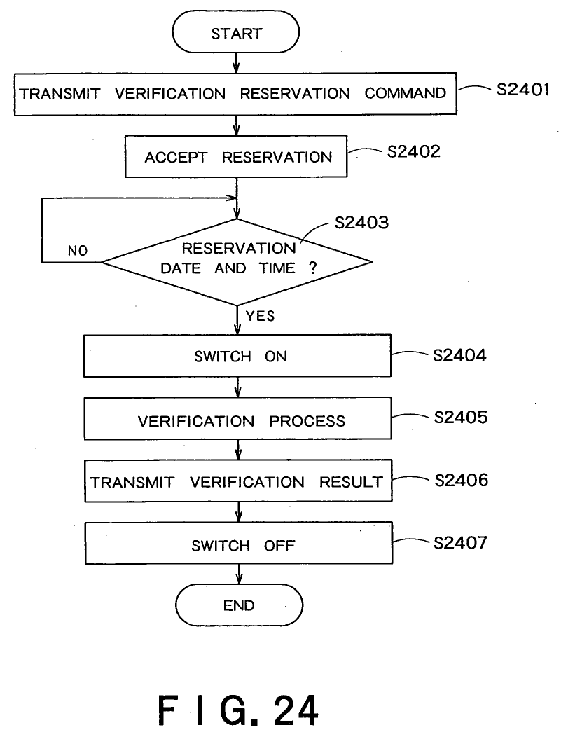

FIG. 24 is a flowchart showing a handling procedure of the verification system for the banknote-and-coin handling system 300 according to the first modified example of the first embodiment of the present invention.

At first, the verification reservation setting unit 325 of the monitor server 320 performs the normal operation via the verification command transmitting unit 322 of the monitor server 320, during which the verification reservation setting unit 325 transmits a verification reservation command (which designates a verification start date and time limited to the night time or the holiday when the operation is not performed) to the banknote-and-coin handling system 300 (S2401).

Then, the verification handling unit 301 of the banknote-and-coin handling system 300 receives the verification reservation command transmitted from the verification reservation setting unit 325 and accepts the reservation (S2402). Note that if the reservation is accepted during the implementation of the normal operations, the coin machine for depositing, dispensing, and sorting and the banknote machine for depositing, dispensing, and sorting conduct the same processes as by the banknote-and-coin handling system 100, and the power sources of the coin machine for depositing, dispensing, and sorting and the banknote machine for depositing, dispensing, and sorting are switched OFF after finishing the normal operations.

When reaching the reservation date and time (S2403-YES), the verification handling unit 301 switches ON the power sources of the coin machine for depositing, dispensing, and sorting and the banknote machine for depositing, dispensing, and sorting (S2404).

Then, the verification handling unit 301 executes the verification process (S2405).

Then, the verification result transmitting unit 302 of the banknote-and-coin handling system 300 transmits the verification result of the verification processing unit 301 to the judging unit 323 of the monitor server 320 (S2406).

Then, the verification processing unit 301 switches OFF the power sources of the coin machine for depositing, dispensing, and sorting and the banknote machine for depositing, dispensing, and sorting (S2407).

The handling by the verification system of the banknote-and-coin handling system according to the first modified example of the first embodiment of the present invention comes to an end after S2407.

Note that the judging process according to the first modified example of the first embodiment of the present invention is the same as the judging process according to the first embodiment of the present invention.

Next, a second modified example of the first embodiment of the present invention will be described.

Note that the same descriptions as those in the first embodiment and the first modified example of the first embodiment of the present invention are omitted.

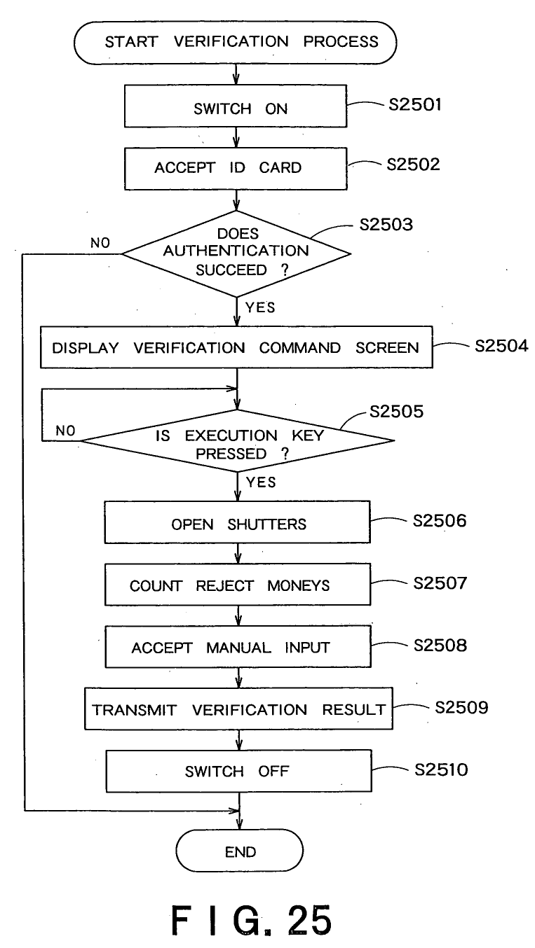

FIG. 25 is a flowchart showing a processing procedure of the verification process according to the second modified example of the first embodiment of the present invention. Note that the verification process according to the second modified example of the first embodiment of the present invention is a process executed after the verification process (S2203 in FIG. 22 or S2405 in FIG. 24) according to a first or second mode of the first embodiment of the present invention and is a process executed before starting the normal operations (e.g., in the morning).

At first, the power sources of the coin machine for depositing, dispensing, and sorting and the banknote machine for depositing, dispensing, and sorting of the banknote-and-coin handling system 300 are switched ON (S2501).

Then, a card reader (not shown) of the banknote-and-coin handling system 300 accepts insertion of an ID card from the operator (S2502).

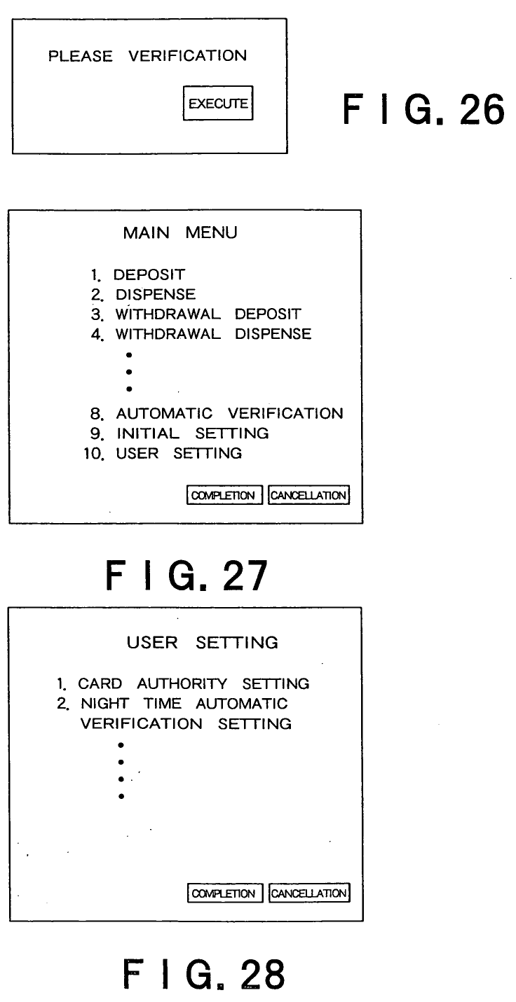

When succeeding in authentication of the ID card (S2503-YES), each of terminal units 111, 114 of the banknote-and-coin handling system 300 displays a verification command screen as illustrated in FIG. 26 (S2504).

When an execution key is pressed (S2505-YES), the shutters of the reject port 122 and the reject accumulating portion 71 of the banknote-and-coin handling system 300 open (S2506). Through this operation, the reject coins in the reject port 122 and the reject banknotes of the reject accumulating portion 71 get an insertable state into the hopper 201 and the banknote input portion 16.

Then, a deposit discriminating portion D1 and the discriminating portion 205 of the banknote-and-coin handling system 300 count the reject moneys (S2507).

Then, the keyboards 113, 116 accept the manual input of the verification result with respect to the reject moneys that are not counted in S2507 (S2508).

Then, the verification result transmitting unit 302 of the banknote-and-coin handling system 300 transmits the verification result of the verification processing unit 301 to the judging unit 323 of the monitor server 320 (S2509).

Next, the verification processing unit 301 switches OFF the power sources of the coin machine for depositing, dispensing, and sorting and the banknote machine for depositing, dispensing, and sorting (S2510).

The verification process according to the second modified example of the first embodiment of the present invention terminates if failing to authenticate the ID card (S2503-NO) or after S2510.

Next, a third modified example of the first embodiment of the present invention will be described. Note that the same descriptions as those in the first embodiment and the first and second modified example of the first embodiment of the present invention are omitted.

At first, when the manager of a branch office as a administrator of the banknote-and-coin handling system 300 inserts the ID card into the card reader (not shown), a menu screen (main menu) as shown in FIG. 27 is displayed on each of terminal portions 111, 114. Then, when the manager of the branch office makes a user setting instruction, a menu screen (user setting screen) as illustrated in FIG. 28 is displayed. When making a card authority setting instruction, the authority of the inserted ID card is authenticated.

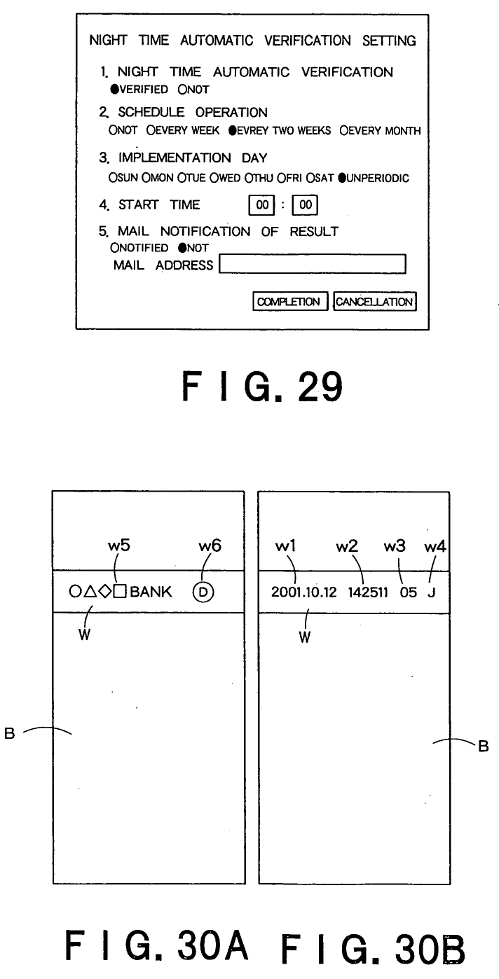

When further making a night-time automatic verification setting instruction if the authentication can be done, a night-time automatic verification setting screen as shown in FIG. 29 is displayed. A desired night-time automatic verification is done in the way that the manager of the branch office specifies respective items on the night-time automatic verification setting screen. On the night-time automatic verification setting screen illustrated in FIG. 29, the items marked with solid black circles represent the indicatively-selected items. To be specific, FIG. 29 shows that the night-time automatic verification is set and conducted at 00:00 (which is, in short, the midnight) on the verification date judged by the predetermined method in every two weeks, and notification of the verification result is not given.

To explain FIG. 29 more specifically, in the case of a schedule operation, the verification data is set based on the setting of the schedule operation by a predetermined method at the beginning of a predetermined period (one week, two weeks, one month). The predetermined method given herein may involve adopting a method of setting the verification date by making a choice based on a random number acquired by a random number generation function of, e.g., the operating system (OS). For example, in the case of every week, a random number showing a probability of 1/7 is acquired at the earliest time in the morning on Monday, and an implementation day of the week is judged. In the case of every two weeks, a random number showing a probability of 1/14 is acquired at the earliest time in the morning on Mondays of every two weeks, and the implementation day of the week is judged. In the case of every month, a random number is acquired from calendar information, and the implementation day is judged.

In the case of being set to an unperiodic automatic verification, it is chosen every day by the predetermined method whether it is the verification date or not, and the night-time automatic verification is automatically performed based on the result of this choice. The predetermined method given herein is that the result of the choice is judged by use of numerals of predetermined values of the time when, for example, the power source has been switched OFF. Herein, it is assumed that the time when the power source has been switched OFF is, e.g., 18:02:32:055 (18 hours: 2 minutes: 32 seconds: 55 mill seconds). The time values up to 18:02 is displayed on the terminal portions 111, 114 of the banknote-and-coin handling system 300, however, the internal timestamp management of the banknote-and-coin handling system 300 can extend to 18:02:32:055. In short, the bank clerk as the operator of the banknote-and-coin handling system 300 recognizes 18:02 from on the screen but can not infer the subsequent time values 32:055 from on the screen.

Hence, if chosen by utilizing the numerical values that can not be inferred by the bank clerk, this bank clerk is disabled from predicting whether the very day is the verification date or not. For example, the last one digit of mill seconds is set to a preset numeral (e.g., 9), and the verification date is validated if equal to 9 but is invalidated if not. In the case of the example given above, the last one digit is 5, and hence the verification date is not validated. If such a technique is adopted, only when “9” among the numerals 0 through 9 is applied, the verification date is validated. Therefore, the probability comes to 1/10, and it follows that the verification is implemented once approximately every 10 days.

Note that the first embodiment of the present invention has exemplified the judging process executed by the monitor server 320, however, the banknote-and-coin handling system 300 may also execute the judging process.

According to the first embodiment of the present invention, the verification is conducted without any advance notice when none of the bank clerks exist in the night time or on the holidays on the basis of the instruction given from the monitor server 320 or the previously-accepted reservation, thereby enabling an accident in cash to be detected surely and quickly without any operation of the person such as the bank clerk.

The verification-enabled scheme without the advance notice according to the first embodiment of the present invention can be attained, whereby the unlawful acts of the bank clerks can be restrained.

The off-duty time verification scheme enables the portal-to-portal hours of the bank clerks to be reduced without causing any hindrances in the financial operation.

The independent verification scheme of the banknote-and-coin handling system 300 according to the first embodiment of the present invention exhibits an effect that no special cost is expended without selecting the place.

### Second Embodiment

Next, a second embodiment of the present invention will be discussed. The second embodiment of the present invention will exemplify an example of printing, on a binding band W, the processing information representing the content of the process executed for the banknote bundle B. Note that the same descriptions as those in the first embodiment of the present invention are omitted.

At first, the binding band W on the surface of the banknote bundle B illustrated in FIG. 30A is affixed with a seal of a financial institute name w5 by a bank name stamp 5c and with a seal of a damaged currency mark w6 by a damaged currency stamp 5d. On the other hand, the binding band W on the undersurface of the banknote bundle B shown in FIG. 30B is printed with a processing date indication w1, a processing time indication (processing time information) w2, a processing machine indication w3 and a process discriminating symbol (process discriminating information) w4 in sequence from the left side by the printer 5b serving as the printing means.

Among these indications, the processing date indication w1 indicates a processing date in, e.g., numerals. The illustrative example shows that the processing date is Oct. 12, 2001 AD. The processing time indication w2 indicates processing time down to the unit of seconds in, e.g., numerals. The illustrative example shows that the processing time is 14:25:11. The processing machine indication w3 indicates a machine serial number of the banknote-and-coin handling apparatus employed for processing. The illustrative example shows that the processing is done by the machine having the machine serial number “5”.

The process discriminating symbol w4 indicates capable of discriminating information showing which type of processing the banknote bundle B has undergone in each processing unit (FIG. 8) in symbols. The process discriminating symbol w4 involves using five alphabetic symbols such as L, K, T, S and J. These symbols are allocated to a variety of processes that will be mentioned later on, such as (1.1) Sorting Process=L, (1.2) Binding Collecting process=K, (1.3) Bound Bundle Dispensation Process=T, (2.1) Binding Load Process=S and (2.2) Intra-Machine Moving Load/Automatic Collecting process=J.

Note that the process discriminating symbol w4 can involve, if capable of discriminating between the processing contents, using, as a matter of course, other alphabets and a variety of symbols such as characters other than the alphabets, numerals and graphic symbols. Information from which to discriminate between the processing contents depending on color-different indications as by a color printer can be considered as the process discriminating information that replaces the process discriminating symbol w4.

Next, a first modified example of the second embodiment of the present invention will be described. Note that the same descriptions as those in the second embodiment of the present invention are omitted.

When only a specified process is executed and so on, in addition to the process discriminating symbol w4 (or as a substitute for the process discriminating symbol w4), operator information capable of specifying the operator getting involved in the process of the banknote bundle B may also be printed on the binding band W. This type of operator information employs, it is considered, the indications such as the numerals, the symbols and initials that are allocated to the individual operators.

On the occasion of performing a follow-up verification, the operator getting involved in the process of the banknote bundle B can be thereby directly specified from the operator information printed on the binding band W. Especially when executing only the specified process and so on, if difficult to perform the follow-up verification simply by directly specifying the processing content, it is effective to directly specify the operator.

The scheme according to the second embodiment of the present invention makes it possible to determine, from the processing information printed on the binding band W, which type of process the banknote bundle B has undergone in each processing unit. This scheme facilitates the follow-up verification in such a case that a fault might occur on the banknote bundle B due to a mistake etc of the operator.

### Third Embodiment

Next, a third embodiment of the present invention will be discussed. The third embodiment of the present invention will exemplify an example of displaying a screen for prompting the operator to restart the system when failing to clear the data or switch OFF the power source. Note that the same descriptions as those in the first and second embodiments of the present invention are omitted.

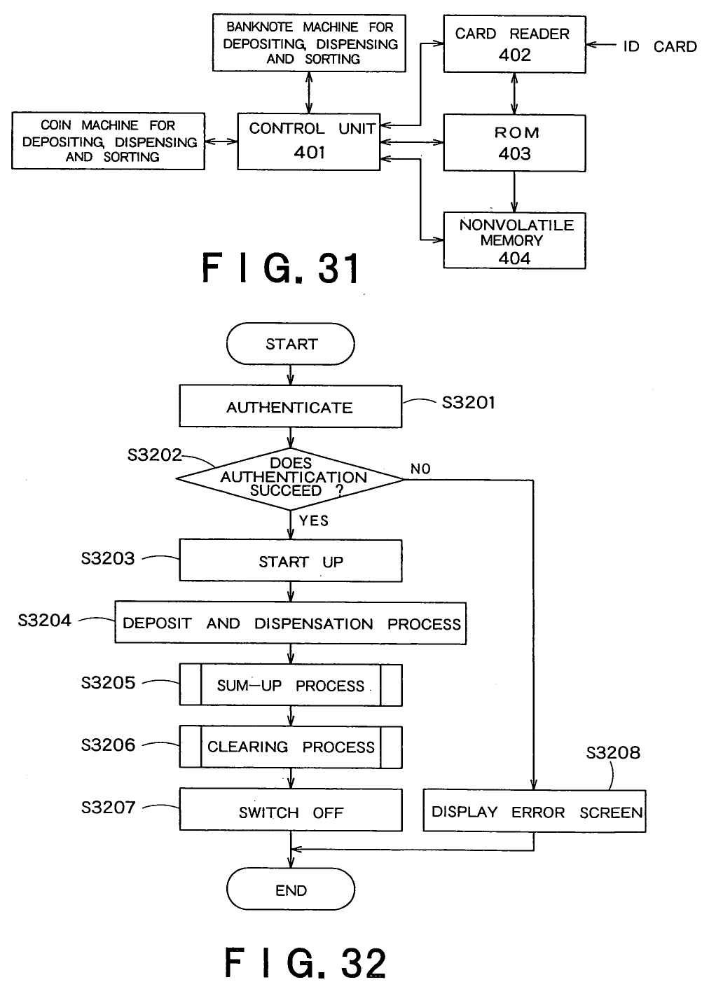

FIG. 31 is a block diagram illustrating a configuration of a banknote-and-coin handling system 400 according to the third embodiment of present invention.

The banknote-and-coin handling system 400 according to the third embodiment of present invention includes a control unit 401, a card reader 402, a ROM (Read-Only Memory) 403 and a nonvolatile memory 404.

The control unit 401 controls the whole system based on a program stored in the ROM 403. The card reader 402, the ROM 403, the nonvolatile memory 404, the coin machine for depositing, dispensing, and sorting and the banknote machine for depositing, dispensing, and sorting are connected to the control unit 401.

The card reader 402 reads the ID stored on the ID card and transmits the readout deposit and dispensation data to the control unit 401.

The ROM 403 is stored with the program for the control unit 401.

The nonvolatile memory 404 is defined as a working memory for the control unit 401 and retains various items of data (such as classified items of deposit and dispensation data of today and deposit and dispensation data of next day).

The coin machine for depositing, dispensing, and sorting and the banknote machine for depositing, dispensing, and sorting are the same as in the first embodiment of the present invention.

FIG. 32 is a flowchart showing a handling procedure when the banknote-and-coin handling system 400 according to the third embodiment of present invention normally operates.

At first, the card reader 402 accepts the ID card and reads the data, then, the control unit 401 authenticates the data (S3201). Note that the third embodiment of present invention permits the control unit 401 to authenticate the data inputted from the keyboards 113, 116.

When succeeding in the authentication in S3201 (S3202-YES), the control unit 401 starts up the coin machine for depositing, dispensing, and sorting and the banknote machine for depositing, dispensing, and sorting (S3203).

Then, the coin machine for depositing, dispensing, and sorting and the banknote machine for depositing, dispensing, and sorting execute the deposit and dispensation process in the same way as in the first embodiment of the present invention (S3204).

Then, a settlement-day advancing process, which will be described alter on, is executed (S3205).

Then, a process of clearing the deposit and dispensation data of today, which will be mentioned later on, is executed (S3206).

When the operator presses a power button, each of the coin machine for depositing, dispensing, and sorting and the banknote machine for depositing, dispensing, and sorting comes to the OFF-state of the power source (S3207).

While on the other hand, if failing to authenticate (S3202-NO), an error screen (not shown) is displayed on each of the terminal portions 111, 114 (S3208).

The process according to the third embodiment of present invention when normally operated comes to an end after S3207 and S3208.

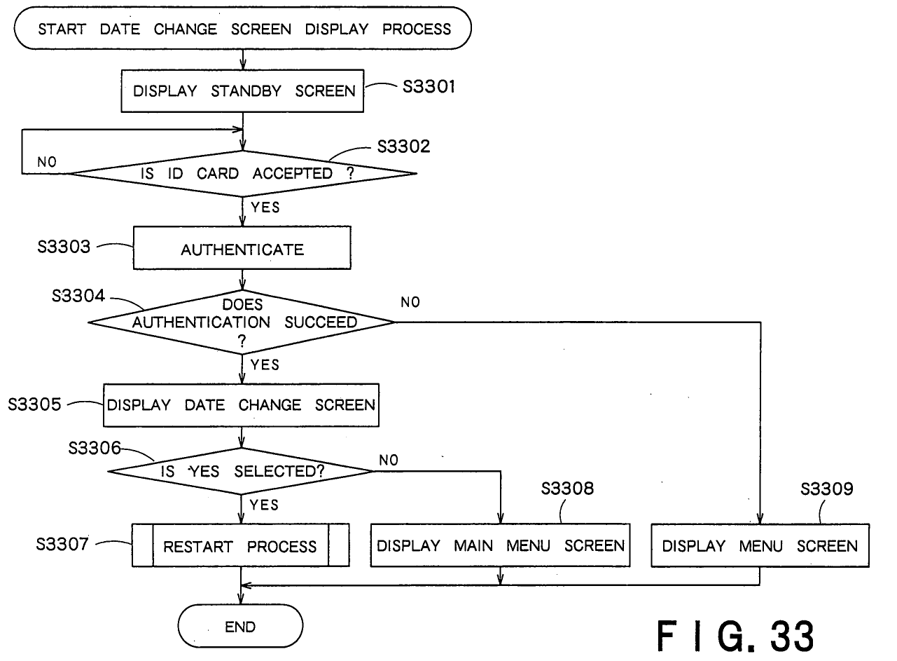

FIG. 33 is a flowchart showing a processing procedure of a date change screen displaying process according to the third embodiment of present invention. Note that the date change process is a process carried out when the date changes after 12:00 am without executing the date advancing process (S3205 in FIG. 32), clearing the data (S3206 in FIG. 32) and switching OFF the power source (S3207 in FIG. 32).

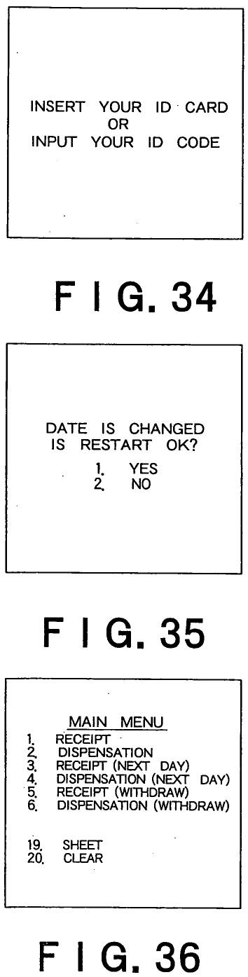

At first, the control unit 401 displays a standby screen as illustrated in FIG. 34 on each of the terminal portions 111, 114 (S3301). For example, the standby screen is displayed when the date changes after 12:00 am without executing the date advancing process (S3205 in FIG. 32), clearing the data (S3206 in FIG. 32) and switching OFF the power source (S3207 in FIG. 32).

Thereafter, the banknote-and-coin handling system 400 stands by till the ID card is accepted by the card reader 402 (S3302-NO). Note that according to the third embodiment of present invention, the banknote-and-coin handling system 400 may stand by till the keyboards 113, 116 accept an input of an ID code.

When the card reader 402 accepts the ID card (S3302-YES), the control unit 401 authenticates the data read by the card reader 402 (S3303). It is to be noted that according to the third embodiment of present invention, the control unit 401 may authenticate the data inputted from the keyboards 113, 116.

When succeeding in the authentication in S3303 (S3304-YES), the control unit 401 displays the date change screen as illustrated in FIG. 35 on the terminal portions 111, 114 (S3305). This operation enables the operator to recognize that the date of the deposit and dispensation data on the settlement day and the date of today have changed. Simultaneously with the changes of the dates, a message [IS RESTART OK?] is displayed, and hence the operator can indicate the restart.

If [1. YES] is selected on the date change screen in FIG. 35, the control unit 401 proceeds to a restart process (S3307).

While on the other hand, the item [2. NO] is selected on the date change screen in FIG. 35, the control unit 401 displays the main menu screen as illustrated in FIG. 36 on the terminal portions 111, 114 (S3308). This operation makes the items selectable such as the normal receipt [1. RECEIPT], the normal dispensation [2. DISPENSATION], the receipt of next day [3. RECEIPT (NEXT DAY)], the dispensation of next day [4. DISPENSATION (NEXT DAY)], the withdrawal receipt [5. RECEIPT (WITHDRAW)], the withdrawal dispensation [6. DISPENSATION (WITHDRAW)], the advanced sheet print [7. SHEET] and the clearance [8. CLEAR]. Namely, if the date has already changed because of being late due to an overtime work, the item [2. NO] is selected. Owing to this selection, the processing can be done in a way that deals with the deposit and dispensation data of the previous day as the deposit and dispensation data of today and the deposit and dispensation data of today as the deposit and dispensation data of next day without executing the restart process (S3307).

Whereas if failing to authenticate in S3303 (S3304-NO), the control unit 401 displays an error screen (not shown) on the terminal portions 111, 114 (S3309).

The date change screen display process according to the third embodiment of present invention terminates after S3307-S3309.

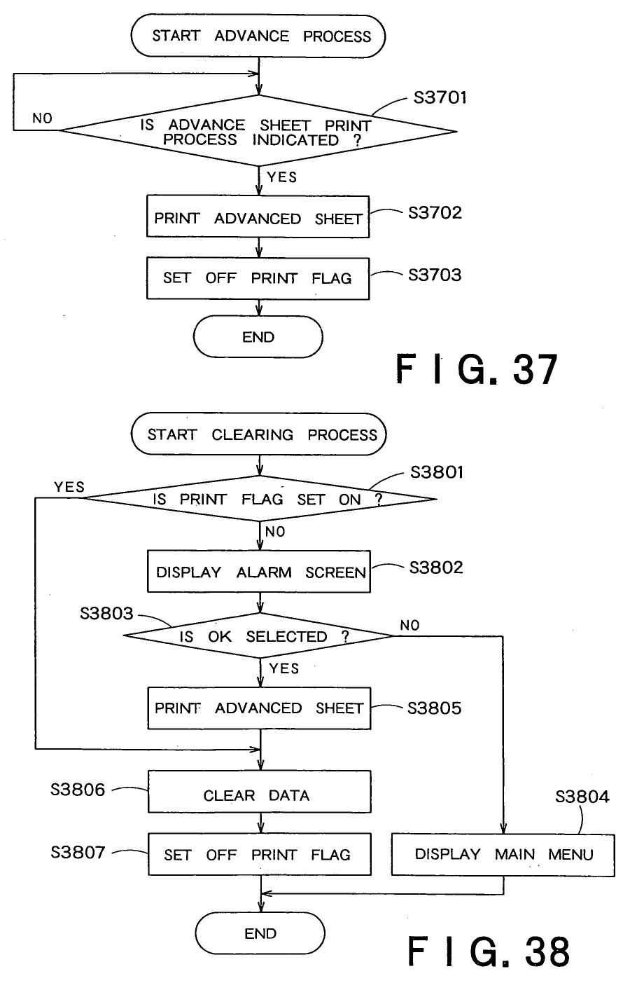

FIG. 37 is a flowchart showing a processing procedure of the advancing process (S3205 in FIG. 32) according to the third embodiment of present invention. The advancing process involves totalizing the deposit and dispensation data of today (the settlement day) and completing a transaction on the settlement day.

At first, when instructed to print the advanced sheet from the keyboards 113, 116 (S3701-YES), printer units 112, 115 print the advanced sheet (S3702).

Next, the control unit 401 sets ON a print flag on the advanced sheet (S3703). The print flag is set for judging whether the advancing process of the deposit and dispensation data of today is carried out or not.

The advancing process according to the third embodiment of present invention is finished after S3703.

FIG. 38 is a flowchart showing a handling procedure of a clearing process (S3206 in FIG. 32) according to the third embodiment of present invention. The clearing process is a process of clearing the deposit and dispensation data of today.

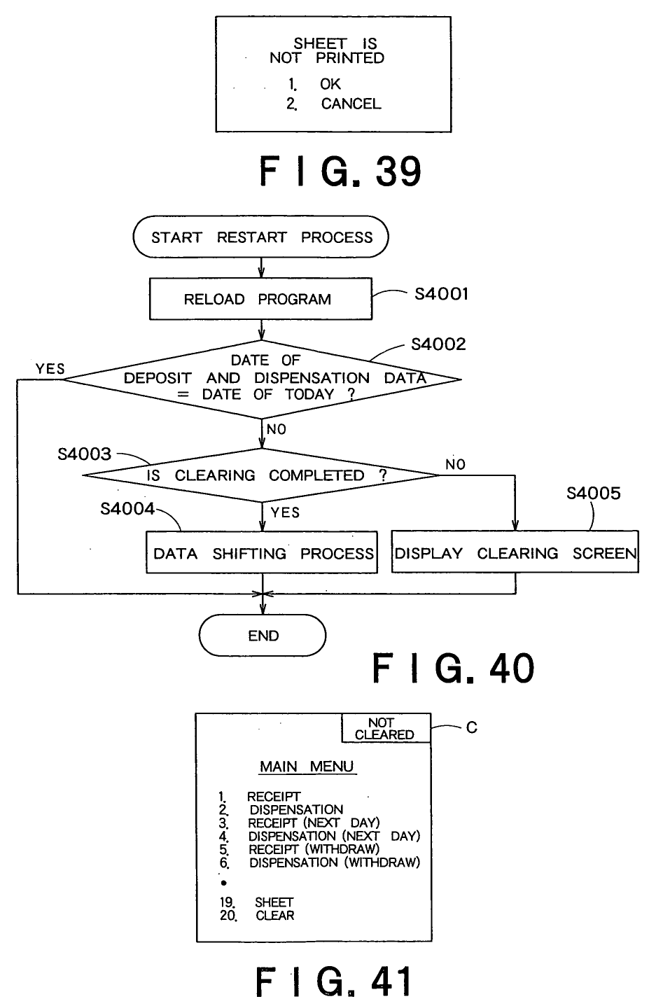

At first, when the print flag is set OFF (S3801-NO), an alarm screen as shown in FIG. 39 is displayed on the terminal portions 111, 114 (S3802).

When the item [1. CANCEL] is selected on the alarm screen in FIG. 39 (S3803-NO), the main menu screen as illustrated in FIG. 36 is displayed on the terminal portions 111, 114 (S3804). Thereafter, for example, the advancing process is redone in a way that informs a higher-up person having the authority to execute the advancing process.

While on the other hand, when [1. OK] is chosen on the alarm screen in FIG. 39 (S3803-YES), the printer units 112, 115 print the advanced sheet of the pre-clearing deposit and dispensation data retained on the nonvolatile memory 404 (S3805).

Then, the control unit 401 clears the deposit and dispensation data corresponding to the advanced sheet printed in S3804 from the nonvolatile memory 404 (S3806).

Then, the control unit 401 sets OFF the print flag (S3807).

The clearing process according to the third embodiment of present invention terminates after S3804 and S3807.

FIG. 40 is a flowchart showing a processing procedure of a restart process (S3307 in FIG. 33) according to the third embodiment of present invention. The restart process is executed when the error occurs in the banknote-and-coin handling system 400. According to the third embodiment of present invention, a data transfer process is conducted during the restart process.

At first, the control unit 401 loads the program from the ROM 403 (S4001).

If the date of the deposit and dispensation data of today is not coincident with the date of today (S4002-NO) and if the deposit and dispensation data has already been cleared (S4003-YES), the data transfer process is conducted (S4004). The data transfer process involves transferring the deposit and dispensation data of next day to the deposit and dispensation data of today.

On the other hand, if the date of the deposit and dispensation data of today is not coincident with the date of today (S4002-NO) and if the deposit and dispensation data is not yet cleared (S4003-NO), the control unit 401 displays a clear-indication C as shown in FIG. 41 on the terminal portions 111, 114 (S4005).

The restart process according to the third embodiment of present invention terminates when the date of the deposit and dispensation data of today is coincident with the date of today (S4002-YES) or after S4004 and S4005.

Note that the startup of the banknote-and-coin handling system 400 is triggered by inserting the ID card or inputting the ID code, however, the startup mode is not limited to this technique if capable of authenticating the operator as being regular.

Note that the date change screen is displayed on the terminal portions 111, 114 after authenticating the operator, however, the alarm mode is not limited to this technique on condition that the operator can confirm the change of date.

According to the third embodiment of the present invention, with the change of date from the settlement day to next day, even if failing to clearing the deposit and dispensation data and failing to switch OFF the power source, the deposit and dispensation process can not be executed unless the predetermined operation is performed based on the date change screen. It is therefore feasible to prevent the operator from mistakenly conducting the deposit and dispensation process.

According to the third embodiment of present invention, even if failing to switch OFF the power source, the necessity for updating the date is explicitly displayed on the date change screen, and the operator is prompted to restart. Hence, it is possible to prevent the process from being done as the continuation from the previous day.

### Fourth Embodiment

Next, a fourth embodiment of the present invention will be discussed. The fourth embodiment of the present invention will exemplify an example of executing a recovery process when the cash under the dispensation gets deficient or a trouble occurs. Note that the same descriptions as those in the first through third embodiments of the present invention are omitted.

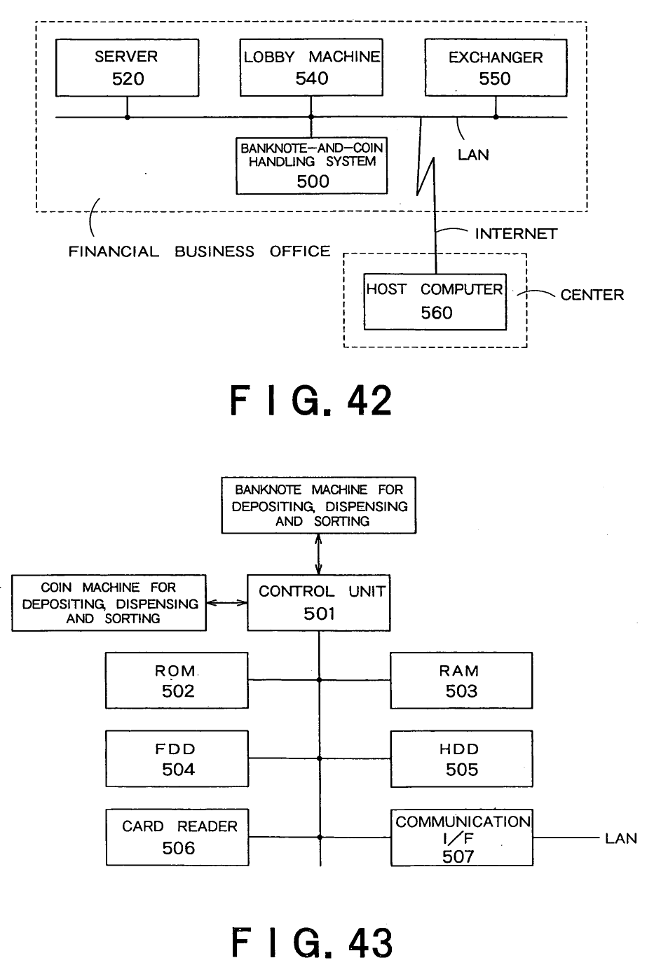

FIG. 42 is a block diagram showing a topology of a banknote-and-coin handling system 500 according to the fourth embodiment of the present invention at a financial business office.

The banknote-and-coin handling system 500 is connected via an in-office LAN (Local Area Network) to a server 520, a lobby machine 540 and a money changer 550. The LAN is connected via the Internet to a host computer 560 at the center.

FIG. 43 is a block diagram illustrating architecture of the banknote-and-coin handling system 500 according to the fourth embodiment of the present invention.

The banknote-and-coin handling system 500 includes a control unit 501, a ROM 502, a RAM (Random Access Memory) 503, a FDD (Flexible Disk Drive) 504, a HDD (Hard Disk Drive) 505, a card reader 506, a communication I/F (Interface) 507, the coin machine for depositing, dispensing, and sorting and the banknote machine for depositing, dispensing, and sorting.

The control unit 501, which is constructed of a CPU (Central Processing Unit) etc, controls the banknote-and-coin handling system 500 according to a program stored in the ROM 502.

The ROM 502 is a readable-by-computer storage medium stored with the program for the control unit 501.

The RAM 503 is a working memory for the control unit 501.

The FDD 504 is a hardware device that reads and writes the data from and to the flexible disk.

The HDD (Hard Disc Drive) 505 is a readable-by-computer storage medium stored with various items of data.

The card reader 506 reads the ID stored on the ID card of the operator and transmits the readout deposit and dispensation data to the control unit 501.

The communication I/F 507 is an interface for performing the communications between the server 520, an ATM (Automatic Teller Machine) 540 and a teller 560 via the LAN.

Next, an advanced dispensation process according to the fourth embodiment of the present invention will be described. The advanced dispensation process is a process in which the banknote-and-coin handling system 500 takes over the dispensation process due to a deficiency of the balance when the customer tried to pay out the money from the lobby machine 540.

The customer performs the same operation at the lobby machine 540 as in the case of withdrawing the money from the normal cash dispensationr.

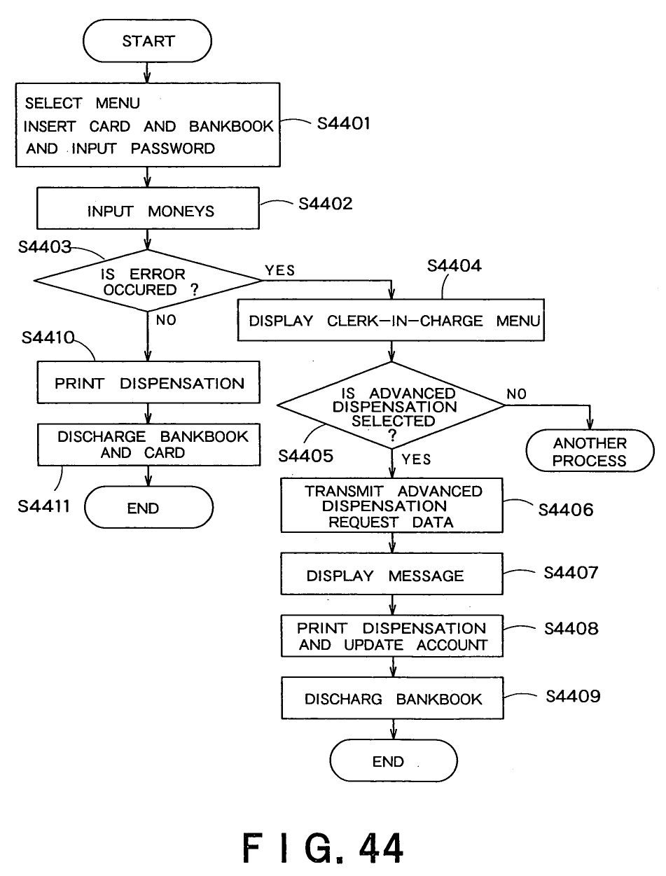

As illustrated in FIG. 44, at first, the customer operates the menu screen in the standby status and selects the “dispensation”, then inputs a password after inserting the card and a bankbook, further inputs a desired denomination and a desired number of moneys, confirms the total amount of moneys, and presses a [confirmation] button (S4401). The machine counts the moneys and starts withdrawing the moneys (S4402), however, if paid in separation because of a large amount of moneys, a sum of moneys is printed on the receipt each time the moneys are discharged.

Herein, for example, in the case of withdrawing 10,000,000 yen, if disabled from withdrawing the 10,000 yen banknotes due to the cash deficiency just when 900 sheets of 10,000 yen banknotes have been paid out (which is also similarly applied to a trouble caused by a banknote jam), the operation thus falls into an error (S4403-YES). A message [please, call the clerk in charge] is displayed, and the customer calls the lobby clerk in charge (S4404).

The lobby clerk in charge displays a guidance screen through a clerk's operation and selects the [advanced dispensation] (S4405-YES), at which time the lobby machine 540 transmits request data of the advanced dispensation to the banknote-and-coin handling system 500 (S4406).

The request data transmitted at that time contains itemized pieces of cash data such as a machine No. a machine name (a name of the lobby machine), a customer ID, a name of the customer, a lobby clerk ID, a name of the clerk, a process ID, a name of the process (the advanced dispensation), transaction acceptance time, a level of priority, denominations needed for the dispensation and a quantity of moneys.

Thereafter, the lobby machine 540 notifies the lobby clerk and the customer of a message saying a purport that the remaining cash will be paid at the window (S4407). Then, the lobby machine 540 issues an advanced dispensation acceptance receipt and simultaneously discharges the bankbook and the card (S4408, S4409). The lobby machine 540 gives a guidance to receive the deficient amount of moneys at the window designated on the screen or in voice by handing over the receipt. The lobby clerk accompanies the customer for the deficient cash reception guidance at the window.

The lobby machine 540, when issuing the advanced dispensation acceptance receipt, draws off the amount of dispensation from an account of this bankbook because of the dispensation being already made.

On the other hand, if the error does not occur, the lobby machine 540 prints the amount of dispensation on the bankbook (S4410) and discharges the bank and the card (S4411).

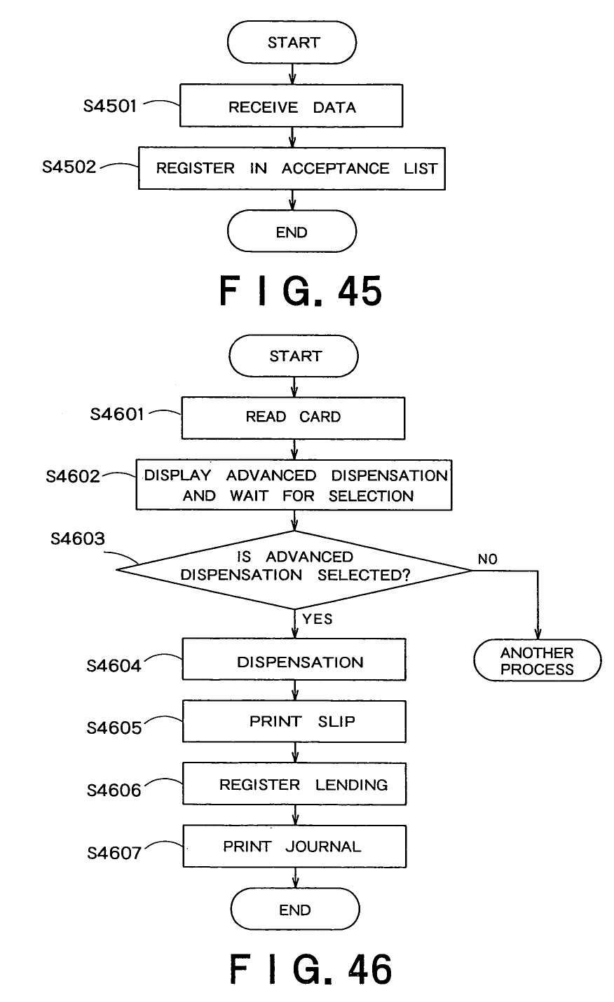

As shown in FIG. 45, the banknote-and-coin handling system 500, when receiving the request data from the lobby machine 540 (S4501), registers the data in an acceptance list corresponding to the content, however, in this case the advanced dispensation is registered (S4502).

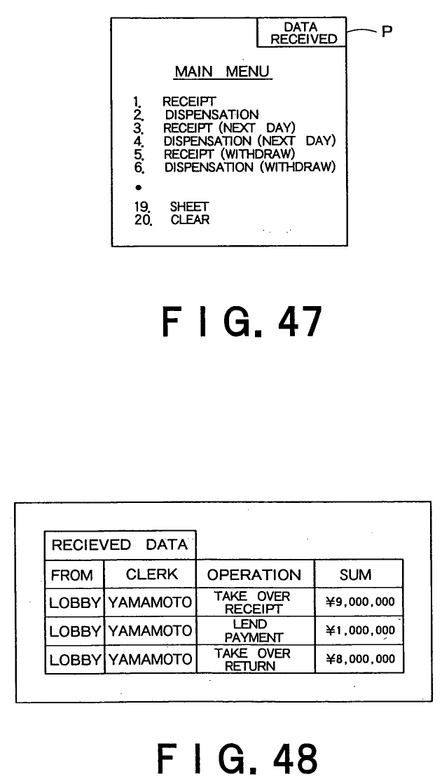

As illustrated in FIG. 46, after a cashier has written out a slip (withdrawal dispensation slip) describing a balance, the banknote-and-coin handling system 500 gives a pop-up notice P on the menu screen as illustrated in FIG. 47 when a card of the person in charge is inserted (S4601). Then, the banknote-and-coin handling system 500 displays the acceptance list as illustrated in FIG. 48 through a key operation (S4602), accepts the selection of the advanced dispensation accepted from the lobby machine 540, and executes the advanced dispensation process of the lobby machine 540 (S4603-YES).

Information showing the amount of money unpaid to the customer is 1,000,000 yen is displayed on the terminal portions 111, 114. The clerk in charge confirms this information and presses a [completion] key, thus withdrawing the cash (S4604). The banknote-and-coin handling system 500 prints the slip (S4605), then stores the advanced money to the lobby machine 540 (S4606) and prints a journal (S4607). The clerk in charge hands over the paid cash of 1,000,000 yen, the bankbook and the card to the customer, thus finishing the transaction.

Note that the lobby machine 540 entrusts the banknote-and-coin handling system 500 with the dispensation of 1,000,000 yen unpaid in a way that sends the data to the banknote-and-coin handling system 500 according to an input of the indication of the lobby clerk, and temporarily completes the dispensation transaction of 1,000,000 yen. At this time, the process is conducted on the assumption that the money (1,000,000 yen in deficiency) needed for the transaction is added and charged into the lobby machine 540.

In this case, the banknote-and-coin handling system 500 pays the cash of 1,000,000 yen entrusted by the lobby machine 540 and repays the cash to the customer. Simultaneously, the banknote-and-coin handling system 500 executes the process on the assumption that the cash of 1,000,000 yen is charged into the lobby machine 540.

Next, a continuous deposit process according to the fourth embodiment of the present invention will be described. The continuous deposit process is a process executed in a case where the deposit process is handed over to the banknote-and-coin handling system 500 due to the occurrence of the error (such as a storage box being full of monies or the banknote jam) even though the customer tried to deposit the money at the lobby machine 540.

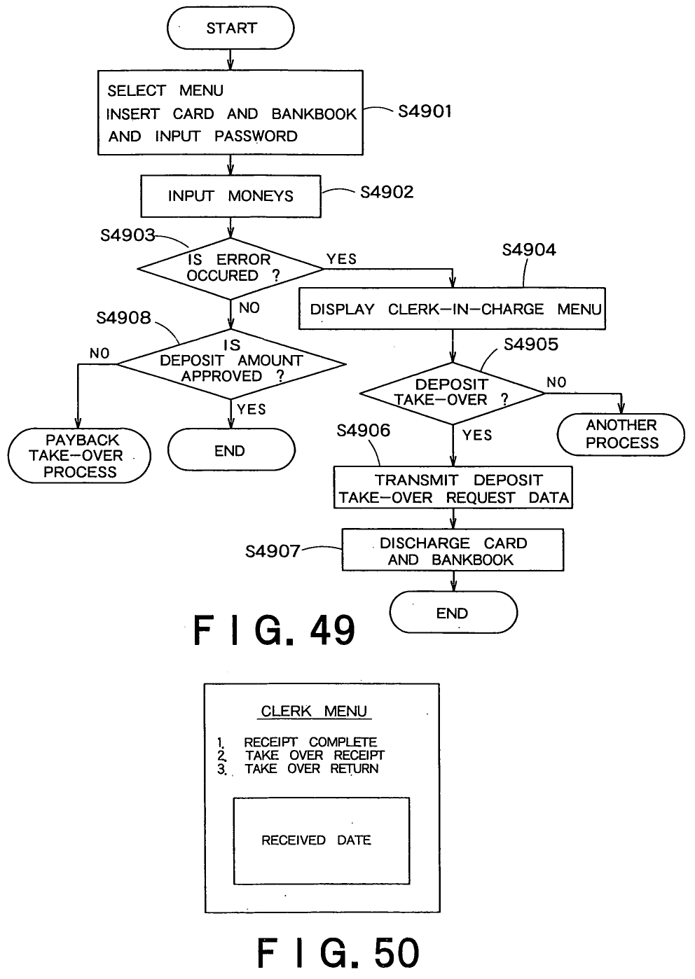

As illustrated in FIG. 49, the customer selects the “deposit” on the menu screen of the lobby machine 540, then inserts the bankbook and the card, and, if an amount of deposit money is known, inputs this amount of deposit money (S4901).

Then, the currencies equivalent to the inputted amount of moneys are inserted (S4902), however, if the deposit amount is large, a scheme is that the moneys are stored into the storage box from the temporary reserving portion each time the temporary reserving portion gets full of the moneys. At this time, the amount of moneys stored in the storage box is printed on the receipt. If necessary for dispensing the moneys back, this amount of moneys is paid back from the banknote-and-coin handling system 500.

If the error occurs at that time (S4903-YES), the message saying [please, call the clerk in charge] is displayed. Then, the lobby clerk comes and inputs a password, and a customer treatment menu of the clerk as illustrated in FIG. 50 is displayed (S4904).

Herein, if the customer does not desire for handing over the deposit to the banknote-and-coin handling system 500 (i.e., the customer desires for completing the deposit with only the data that has already been stored) and if [1. RECEIPT COMPLETE] in FIG. 50 is selected (S4905-NO), the operation gets completed directly. If the customer desires for canceling the process (i.e., the customer desires for payback of the already-stored cash) and if [3. TAKE OVER RETURN] in FIG. 50 is selected, a payback take-over process, which will be described later on, is conducted.

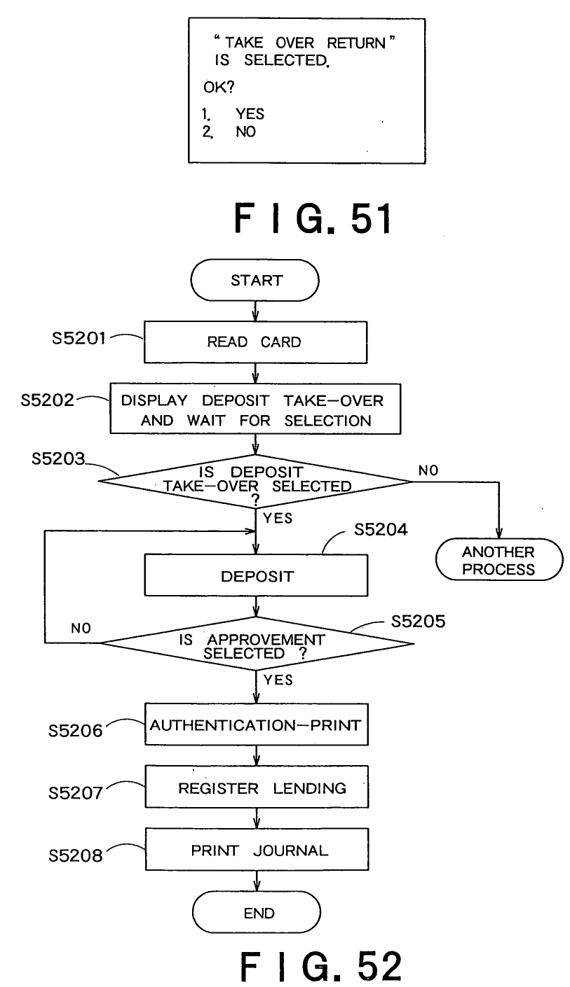

If the customer desires for taking over the deposit and [2. TAKE OVER RECEIPT] in FIG. 50 is chosen (S4905-YES), the data containing an amount of transaction and an amount of already-deposited money is transmitted to the banknote-and-coin handling system 500 (S4906). To be specific, if [1. YES] in FIG. 51 is selected, the data is transmitted.

Thereafter, the lobby machine 540 prints the amount of deposit on the bankbook, and discharges the card and the bankbook (S4907). The lobby clerk, if the cash exists in the temporary reserving portion, takes out the cash. Herein, the lobby clerk temporarily transfers the receipt, the bankbook and the cash to the cashier.

As illustrated in FIG. 45, the banknote-and-coin handling system 500, when receiving the request data from the lobby machine 540 (S4501), registers the data corresponding to the content thereof in the acceptance list, however, the deposit take-over is registered in this case (S4502).

Hereafter, as shown in FIG. 52, the cashier writes out the slip for the deposit, then goes to and inserts the person-in-charge card into the banknote-and-coin handling system 500 (S5201). The banknote-and-coin handling system 500, to which the deposit take-over data given from the lobby machine 540 has been transmitted, gives the pop-up notice P on the menu screen as illustrated in FIG. 47 when the person-in-charge card is inserted (S5202). The banknote-and-coin handling system 500 displays the acceptance list as shown in FIG. 48 and, when [TAKE OVER RECEIPT] in FIG. 48 is selected, starts the deposit take-over process. The deposit take-over process involves displaying the deposit amount declared as a present completion-of-deposit amount. Therefore, the cashier compares this value with the content of the slip and, if OK, presses the [completion] button (S5203).

Then, when setting the deposit moneys and presses the start button, the cash is fed in and counted (S5204), and the deposit amount is displayed on the menu screen. If this deposit amount is coincident with the amount written on the slip (S5205-YES), an authentication print is done on the slip (S5206). Then, the clerk in charge returns the bankbook and the cash to the customer, and the information of being borrowed from the lobby machine 540 is registered (S5207). Thereafter, the journal is printed (S5208), and the transaction is finished.

Next, a payback take-over process according to the fourth embodiment of the present invention will be described. The payback take-over process is a process executed in such a case that the customer tries to deposit the money at the lobby machine 540, however, the deposit is canceled due to the error (such as the storage box being full of monies or the banknote jam) occurring in the middle of the operation, and the banknote-and-coin handling system 500 takes over a process for an amount of takeout-disabled moneys which have already been stored in the storage box of the lobby machine 540.

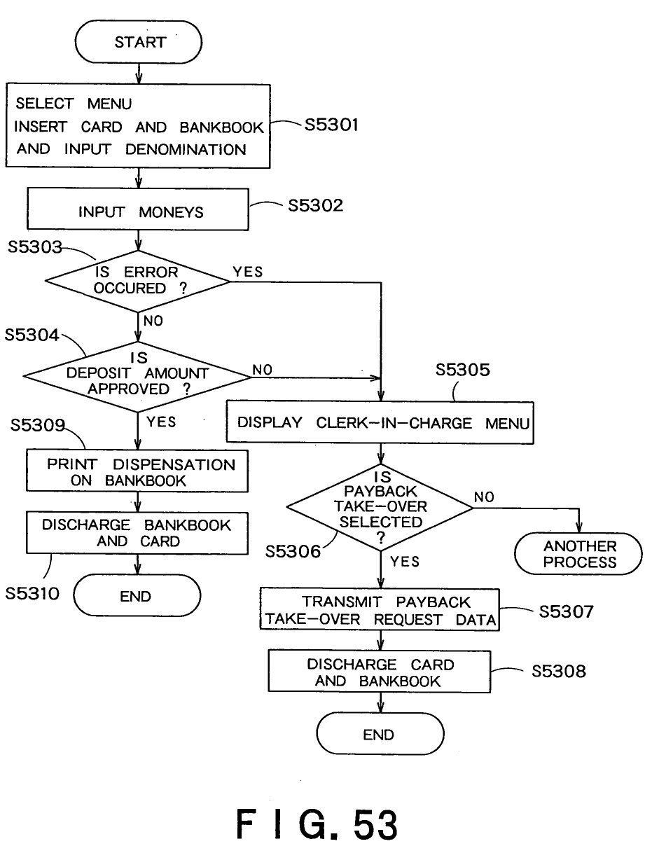

As illustrated in FIG. 53, the customer selects “deposit” on the menu screen of the lobby machine 540, inserts the card and the bankbook and, if the deposit amount is known, inputs this deposit amount (S5301). Then, the deposit moneys are inputted (S5302), however, if the deposit amount is large, the scheme is that the moneys are stored into the storage box from the temporary reserving portion each time the temporary reserving portion gets full of the moneys. At this time, the amount of moneys stored in the storage box is printed on the receipt. If necessary for dispensing the moneys back, this amount of moneys is paid back from the banknote-and-coin handling system 500.

Herein, if the error occurs (S5303-YES) and if confirmation of the deposit amount is not approved after finishing the deposit (S5304-NO), the customer presses a [cancel key]. Then, the message saying [please, call the clerk in charge] is displayed, and the lobby clerk comes and inputs the password, thereby displaying a clerk-in-charge menu as illustrated in FIG. 50 (S5305).

If the customer desires for the amount of already-stored moneys and [3. TAKE OVER RETURN] is selected (S5306-YES), the lobby machine 540 transmits the data containing the transaction amount and the payback amount to the banknote-and-coin handling system 500 (S5307). Thereafter, the lobby machine 540 discharges the card and the bankbook (S5308). The lobby machine 540, if the cash exists in the temporary reserving portion, takes out the cash. Herein, the lobby clerk temporarily transfers the receipt, the bankbook and the cash to the cashier. Note that the lobby clerk does not yet transfer these assets to the customer at this stage.

As illustrated in FIG. 45, the banknote-and-coin handling system 500, when receiving the request data from the lobby machine 540 (S4501), registers the data corresponding to the content thereof, however, the payback take-over is registered in this case (S4502).

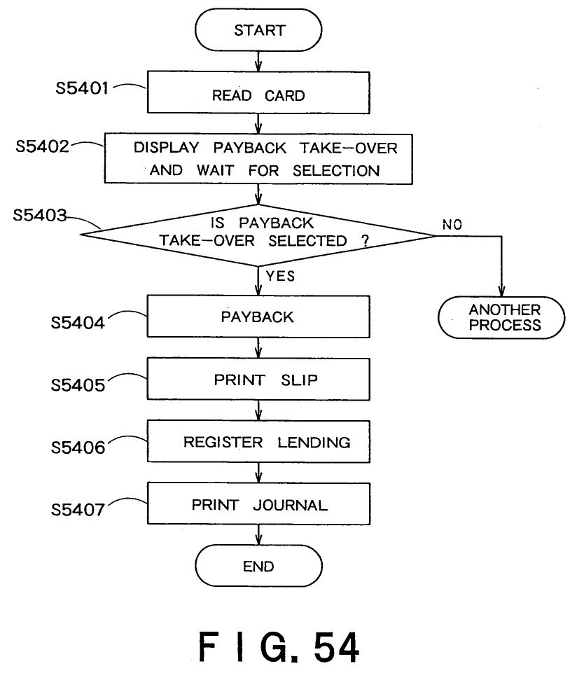

Thereafter, as illustrated in FIG. 54, the cashier writes out the slip for the payback, then goes to and inserts the person-in-charge card into the banknote-and-coin handling system 500 (S5401). The banknote-and-coin handling system 500, to which the deposit take-over data given from the lobby machine 540 has been transmitted, gives the pop-up notice P on the menu screen as illustrated in FIG. 47 when the person-in-charge card is inserted (S5402). The banknote-and-coin handling system 500 displays the acceptance list as shown in FIG. 48 and, when [TAKE OVER RECEIPT] in FIG. 48 is selected, starts the payback take-over process (S5403-YES).

The payback take-over process involves displaying the number of moneys stored in the lobby machine 540. Therefore, the cashier compares this value with the content of the slip and, if OK, presses the [completion] button. Then, the banknote-and-coin handling system 500 performs the payback process of feeding out and counting the cash, and displaying the amount of dispensation on the menu screen (S5404). If this dispensation amount is coincident with the amount of money written on the slip, the clerk in charge makes an authentication print on the slip (S5405) and returns the bankbook and the cash to the customer. The banknote-and-coin handling system 500 registers the information of making the loan to (loading the banknotes and coins into) the lobby machine 540 (S5406). Thereafter, the journal is printed (S5407), and the transaction is finished.

Next, an exchange process according to the fourth embodiment of the present invention will be described. An exchanger 550 checks the balances on a denomination-by-denomination basis during the standby status or when finishing the transaction. The exchanger 550 determines whether replenishment or withdrawal is required or not and, if required, transmits data about a loading request and a withdrawal request to the banknote-and-coin handling system 500. Simultaneously, when notifying the cashier of an event by a buzzer etc, the cash can be replenished and withdrawn without taking trouble to go and see the exchanger 550. The exchanger 550 normally changes the moneys of the higher-denominations into the moneys of the lower denominations and therefore gets full of the 10,000 yen banknotes but gets deficient of the packed coins, the 1,000 yen banknotes, etc. Hence, the efficiency can be increased by replenishing the exchanger 550 with the 1,000 yen banknotes and the packed coins and withdrawing the 10,000 yen banknotes, simultaneously.

The exchanger 550 is provided with an balance-detecting unit (not shown) for detecting intra-machine storage moneys. The balance detecting unit determines that the replenishment is needed when the balance of a specified denomination is lower than a set amount A (empty detection balance), and determines that the withdrawal is needed when exceeding a set amount B (near-full detection balance). The balance detecting unit transmits the request data containing the denominations and the quantities of the moneys that need replenishing and withdrawing to the banknote-and-coin handling system 500 via the communication I/F (not shown).

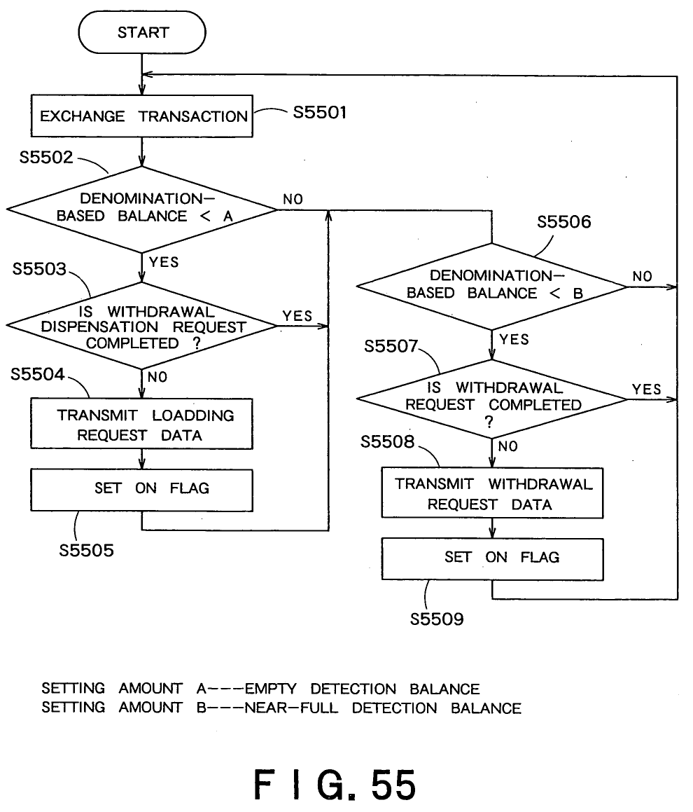

FIG. 55 is a flowchart showing a handling procedure of the exchange process according to the fourth embodiment of the present invention.

After conducting the normal exchange transaction (S5501), the balance detecting unit (not shown) checks the balance on the denomination-by-denomination basis during the standby status or after finishing the transaction. If the balance of the specified denomination is lower than the set amount A (S5502-YES) but when the withdrawal dispensation request for the denomination concerned is not yet completed (S5505-NO), loading request data of the denomination concerned is transmitted to the banknote-and-coin handling system 500 (S5504). Then, a flag showing that the loading request has already been made about the denomination concerned is set (S5505), and the operation proceeds to S5506. Note that S5503 is so provided as not to make any dual request for the denomination about which the loading request flag is set.

On the other hand, if the balance of the specified denomination exceeds the set amount B (S402-NO, S406-YES) and when the withdrawal request about the denomination concerned is not yet completed (S5507-NO), the withdrawal request data of the denomination is transmitted to the banknote-and-coin handling system 500 (S5508). Then, a flag showing that the withdrawal request about the denomination is set (S5509). Note that S5507 is so provided as not to make any dual request for the denomination about which the withdrawal request flag is set.

As illustrated in FIG. 45, the banknote-and-coin handling system 500, when receiving the request data from the lobby machine 540 (S4501), registers the data corresponding to the content thereof, however, the withdrawal deposit and receipt is registered in this case (S4502).

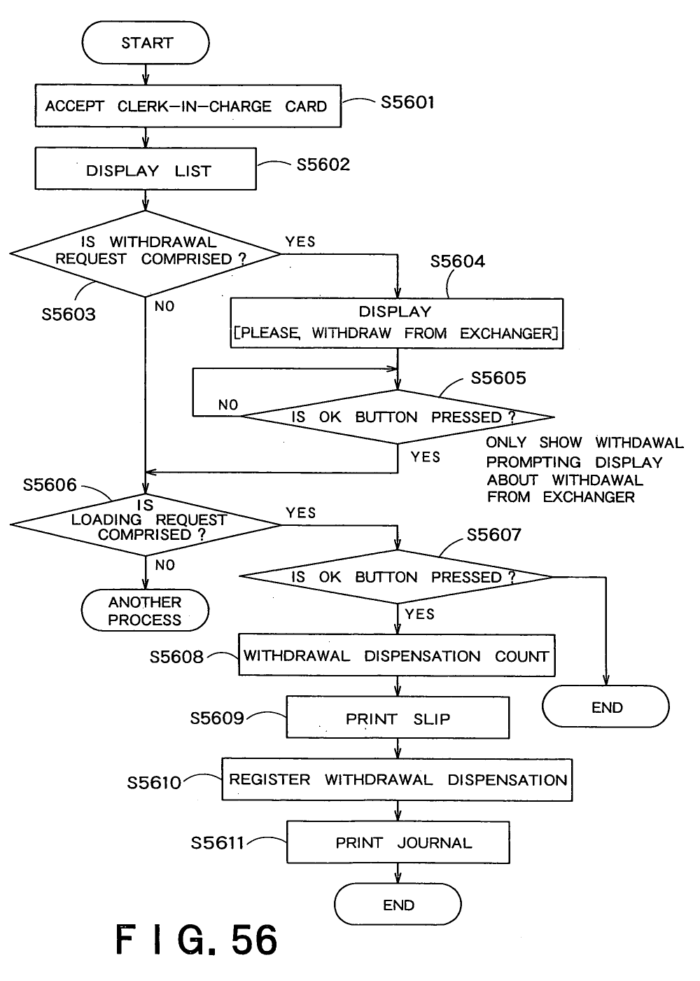

As shown in FIG. 56, when the person-in-charge card of the cashier is inserted through the banknote-and-coin handling system 500 (S5601), the banknote-and-coin handling system 500 displays the acceptance list (S5602). If the list contains the withdrawal request (S5603-YES) and if this request is selected, a message saying [please, withdraw from the exchanger] is displayed (S5604). Consequently when an OK button (confirmation key) is pressed (S5605-YES), the operation proceeds to S5606.

Further, if the request list contains a loading request (S5603-NO, S5606-YES) and when a withdrawal dispensation process for withdrawing and dispensing the moneys to be loaded is selected (S5607-YES), the withdrawal moneys with which the exchanger 550 is replenished are paid out (S5608), and the authentication print is conducted on a withdrawal dispensation slip (S5609).

An amount of the withdrawal dispensation is registered in the banknote-and-coin handling system 500 as what has been lent to the exchanger 550 (S5610), then the journal is printed (S5611), and the process terminates.

The paid-out withdrawal moneys are loaded (replenished) into the exchanger 550 by the clerk in charge.

According to the fourth embodiment of the present invention, the data about the deficiency of the cash under the dispensation and the data for the recovery process against the occurrence of the trouble are transferred via the LAN to the banknote-and-coin handling system 500, the cash is paid out based on these items of data, and hence the banknote-and-coin handling system 500 can make the recovery (the continuous deposit, the pay-back for the deposit, the continuous dispensation, etc) with respect to the remaining processes that can not be completed by the lobby machine 540.

According to the fourth embodiment of the present invention, even in the case of replenishing and loading the exchanger 550 with the moneys of the deficient denominations, the cashier simply selects the withdrawal dispensation menu that is list-displayed on the banknote-and-coin handling system 500 without reckoning the denominations and the number of moneys, whereby the necessary number of moneys of the necessary denominations are output, and the operation efficiency can be increased.

### Fifth Embodiment

Next, a fifth embodiment of the present invention will be discussed. The fifth embodiment of the present invention exemplifies an example in which when the deposit process and the dispensation process are executed in parallel and if a fault occurs in one process, the other process is stopped at a predetermined stage. Note the same explanations as those in the first through fourth embodiments of the present invention are omitted.

A banknote-and-coin handling system according to the fifth embodiment of the present invention is the same as the banknote-and-coin handling system 100 according to the first embodiment of the present invention.

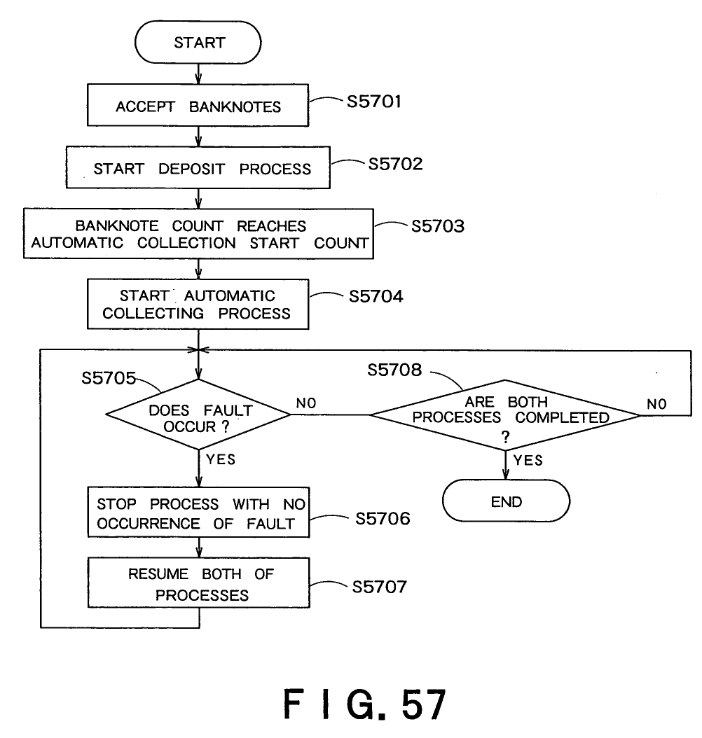

FIG. 57 is a flowchart showing a handling procedure of a deposit and dispensation process by a loose banknote deposit and dispensation unit 103 according to the fifth embodiment of the present invention.

At first, the clerk in charge inserts the loose banknotes into a deposit accumulating portion 70 via the banknote input portion 16 (S5701). Herein, an assumption is that 200 sheets of 10,000 yen banknotes are inserted. The clerk in charge instructs the terminal portion 111 to execute the deposit process by use of the keyboard 113, and the terminal portion 111 gets the loose banknote deposit and dispensation unit 103 to start the deposit process (S5702).

To be specific, the loose banknote deposit and dispensation unit 103 feeds out the 10,000 yen banknotes on the one-by-one basis, which have been inserted into the deposit accumulating portion 70, to the deposit carrying path R1. The deposit discriminating portion D1 discriminates between the fed-out banknotes about the denominations and the undamaged and damaged state, and the treatment-disabled banknotes are sent to the reject accumulating portion 71, while the normal 10,000 yen banknotes are sent to the surface and undersurface inverting portion 73. The loose banknote deposit and dispensation unit 103 aligns the 10,000 yen banknotes to be oriented in a predetermined direction and thus feeds out the banknotes at the surface and undersurface inverting portion 73. The loose banknote deposit and dispensation unit 103 stores the fed-out 10,000 yen banknotes in the temporary reserving portion 84 corresponding to their denominations. Herein, it is assumed that the 10,000 yen banknotes are stored in the temporary reserving portion 84. The clerk in charge, after confirming that a fixed number (50 sheets in the present example) of 10,000 yen banknotes have been stored in the temporary reserving portion 84, inputs a deposit settlement instruction to the terminal portion 111. The terminal portion 111 receiving the deposit settlement instruction outputs a storage instruction to the loose banknote deposit and dispensation unit 103. The loose banknote deposit and dispensation unit 103 receiving the storage instruction stores the 50 sheets of 10,000 yen banknotes into the corresponding banknote storage portion 8b.

The terminal portion 111 always monitors the number of loose banknotes stored in the banknote storage portions 8b-8d. The terminal portion 111, when a stored banknote count reaches an automatic collection start count (S5703), instructs the loose banknote deposit and dispensation unit 103 to start an automatic collecting process. The automatic collecting process is a process of leaving only an automatic collection end count of the loose banknotes among the stored loose banknotes in the loose banknote cassette that have reached the automatic collection start count, and getting the bundle sorting dispensation unit 104 to bundle and store other loose banknotes given by [automatic collection start count—automatic collection end count]. Herein, the automatic collection start count is set to 800 banknotes, and the automatic collection end count is set to 300 banknotes.

Herein, in S5702, an assumption is that the number of 10,000 yen banknotes in the banknote storage portion 8b reaches 800 just when 50 sheets of 10,000 yen banknotes are stored in the banknote storage portion 8b.

The terminal portion 111 detects that the number of 10,000 yen banknotes in the banknote storage portion 8b reaches 800. The terminal portion 111 instructs the loose banknote deposit and dispensation unit 103 to start the automatic collecting process of 500 sheets of loose banknotes given by [800−300=500]. The loose banknote deposit and dispensation unit 103 receiving the automatic collecting process starting instruction starts collecting the loose banknotes in the banknote storage portion 8b (S5704).

More specifically, at first, the loose banknote deposit and dispensation unit 103 sequentially feeds out a predetermined unit count (which is equivalent to 100 sheets in the present example) of 10,000 yen banknotes within the banknote storage portion 8b, and the fed-out banknotes are collected by the stackers 76a, 76b. The loose banknote deposit and dispensation unit 103 transfers 100 sheets of 10,000 yen banknotes collected by the stackers 76a, 76b to the bundle sorting dispensation unit 104. The bundle sorting dispensation unit 104 bundles and thus stores 100 sheets of 10,000 yen banknotes received. The process described above is executed totally five times, thereby storing totally five bundles of 10,000 yen banknotes into the bundle sorting dispensation unit 104. On the other hand, the loose banknote deposit and dispensation unit 103 executes the deposit process for other banknotes (remaining 150 sheets of 10,000 yen banknotes) in parallel with the automatic collecting process.

The terminal portion 111, in the middle of executing the both processes (the deposit process and the automatic collecting process) in parallel, monitors whether or not a fault such as the banknote jam occurs during the deposit process or the automatic collecting process (S5705). Herein, in the middle of the first collecting process (of collecting a first set of 100 sheets) of the automatic collecting process, it is assumed that the banknote jam occurs during the deposit process, and the terminal portion 111 detects this jam (S5705-YES). For example, the assumption is that the banknote jam occurs in the surface and undersurface inverting portion 73 or on the deposit carrying path R1.

The terminal portion 111 detecting the occurrence of the banknote jam gets the loose banknote deposit and dispensation unit 103 to temporarily stop the automatic collecting process at a predetermined stage (a proper stop point) (S5706). For example, just when collecting the 100 sheets of 10,000 yen banknotes in the stackers 76a, 76b (just when the first collecting process is finished), or just when the 100 sheets of 10,000 yen banknotes collected in the stackers 76a, 76b are fed out to the bundle sorting dispensation unit 104, or just when the 100 sheets of 10,000 yen banknotes fed out to the bundle sorting dispensation unit 104 are bundled with the band, or just when the banknotes bundled with the band are stored in the bundle sorting dispensation unit 104, the terminal portion 111 temporarily stops the automatic collecting process.

The clerk in charge opens a drawer and a door of the loose banknote deposit and dispensation unit 103 of which the automatic collecting process has been interrupted, then removes the jammed deposit banknotes and the deposit banknotes in the middle of being carried, and performs a predetermined operation. Thereafter, the clerk gives an instruction of resuming the deposit process and the automatic collecting process to the terminal portion 111. The terminal portion 111 receiving this instruction gets the loose banknote deposit and dispensation unit 103 to resume the deposit process and the automatic collecting process (S5707).

It is further assumed that thereafter, when executing the deposit process and the automatic collecting process in parallel, the banknote jam occurring during the automatic collecting process this time (S5705-YES). In this case, the terminal portion 111 gets the loose banknote deposit and dispensation unit 103 to temporarily stop the deposit process at the predetermined stage (S5706). For instance, just when a fixed number, i.e., 50 sheets of 10,000 yen banknotes are stored in the temporary reserving portion 84, or just when the 50 sheets of 10,000 yen banknotes stored in the temporary reserving portion 84 are transferred to the banknote storage portion 8b, the deposit process is temporarily stopped. Then, after the clerk in charge has removed the jammed dispensation banknotes and the dispensation banknotes in the middle of being carried, the both processes resume (S5707). Till the both processes are completed (S5708-YES), the steps S5705-S5707 are repeated (S5708-NO).

The fifth embodiment of the present invention has exemplified the example of the banknote jam as the fault against the deposit process and the dispensation process, however, the fault is not limited to the banknote jam but embrace troubles occurring from other causes. For example, the fault includes a trouble that stops one process due to a hardware trouble in the middle of carrying the banknotes.

The fifth embodiment of the present invention has further exemplified mainly the automatic collecting process by way of an example of the dispensation process, but, as described above, embraces the normal dispensation process, i.e., a process of withdrawing the designated number of banknotes of the designated denominations to the loose banknote dispensation port 18. In this case, if the fault occurs during the deposit process, the stage for stopping the dispensation process might be exemplified such as a stage after carrying a preset maximum-storage count of loose banknotes to the dispensation accumulating portion 75.

In the fifth embodiment of the present invention, note that the ROM and the HDD stored with the program for controlling the loose banknote deposit and dispensation unit 103 and the control unit for controlling the loose banknote deposit and dispensation unit 103 by executing this program, may be provided within the terminal portion 111 and may also be provided within the loose banknote deposit and dispensation unit 103.

Further, in the fifth embodiment of the present invention, note that the loose banknote deposit and dispensation unit 103 is controlled based on the program, however, this control may be done based on the hardware.

According to the fifth embodiment of the present invention, if the fault occurs during one process when executing the banknote deposit process and the banknote dispensation process in parallel, the other process is temporarily stopped at the predetermined stage, thereby enabling reduction of a probability that the faults might occur during both of the processes, simultaneously.

Namely, in the example where the fault occurs during the deposit process in the middle of the first collecting process (the first set of 100 sheets) of the automatic collecting process, the automatic collecting process is temporarily stopped at a point of time when 100 sheets of loose banknotes in collecting target 500 sheets of loose banknotes are collected by the stackers.

Still further, according to the fifth embodiment of the present invention, it is thus feasible to reduce the probability that the faults might occur during the deposit process and the dispensation process simultaneously, and hence, when the clerk in charge removes the jammed banknotes and the banknotes in the middle of being carried, there can be decreased a possibility of making a misjudgment about whether fault-occurred banknotes are the deposit banknotes or the dispensation banknotes. Consequently, a possibility of causing a discrepancy in calculation between the deposit process and the dispensation process can be reduced.

### Sixth Embodiment

Next, a sixth embodiment of the present invention will be discussed. The sixth embodiment of the present invention exemplifies an example in which banknote and coin handling system is provided with two terminals which concurrently operate. Note the same descriptions as those in the first through fifth embodiments of the present invention are omitted.

A configuration of the banknote and coin handling system 100 according to the sixth embodiment of the present invention will be discussed.

In the banknote and coin handling system 100 according to the sixth embodiment of the present invention, the terminal unit 111 is configured to operate as a main terminal and the terminal unit 114 is configured to operate as a sub terminal. The terminal units 111 and 114, respectively, are provided with hard disc drives which can store any data.

A data sharing function of the banknote and coin handling system 100 according to the sixth embodiment of the present invention will be discussed.

In the data sharing function, the terminal units 111 and 114, respectively, are configured to write a journal data, in which handling data (machine setting data, transaction data and so on) for a handling executed according to a command of an operator is recorded, into their hard disc drives. The terminal units 111 and 114, respectively, are configured to synchronize the both hard disc drives, if needed. As a result, the same data have been stored in the both hard disc drives of the terminal units 111 and 114. The terminal unit 111 is configured to be capable of accessing the data stored in the hard disc drive of the terminal unit 114. The terminal unit 114 is configured to be capable of accessing the data stored in the hard disc drive of the terminal unit 111.

An exclusive control function of the banknote and coin handling system 100 according to the sixth embodiment of the present invention will be discussed.

In the exclusive control function, the terminal unit 111 which operates as the main terminal is configured not only to execute a handling according to the command of the operator but also to monitor the terminal unit 114 which operates as the sub terminal. When there is an exclusive relationship between the both handlings executed by the terminal units 111 and 114, for example each feed route in the both handlings overlaps, the terminal unit 111 is configured to send a command for stopping the handling to the terminal unit 114. Then, the terminal unit 114 is configured to display an alerting message showing that the handling is prohibited. In this regard, however if the operator hopes that the terminal unit 114 will execute the handling (a second handling) for depositing banknotes when the terminal unit 111 is executing the handling (a first handling) for depositing banknotes, the operator can manually input the information about the second handling. At this point, after the alerting message is displayed, the operator inputs banknote information to be handled in the second handling and selects a storing location (for example, the post unit 117) for the banknotes using keyboard 116. This post unit 117 is a storage bin without counting function for banknotes. Then, the operator deposits banknotes to the post unit 117. At this point, the banknote information input by the operator is stored in the hard disc drive of the terminal unit 114.

According to the sixth embodiment of the present invention, two terminal units 111 and 114, respectively, share handling data. Therefore, even if one of them is breakdown, data stored in the hard disc drive of the other is available.

According to the sixth embodiment of the present invention, the terminal unit 111 which operates as main terminal exclusively controls the terminal unit 114 which operates as sub terminal. Therefore, when a plurality of terminal units concurrently execute a plurality of handlings, an error arising from the exclusive relationship between at least two handlings can be prevented.

What is claimed is:

1. A verification system for a banknote-and-coin handling system, comprising:
a banknote machine for depositing, dispensing, and sorting that handles banknotes and a coin machine for depositing, dispensing, and sorting that handles coins; and
a monitor server connected to said banknote-and-coin handling system,
said coin machine for depositing, dispensing, and sorting including:
a hopper accepting inputted loose coins;
a discriminating portion discriminating between the loose coins accepted by said hopper; and
coin storage portions stored with the loose coins on a denomination-by-denomination basis on the basis of a result of the distinction made by said discriminating portion,
said banknote machine for depositing, dispensing, and sorting including:
a banknote input portion accepting the inputted loose banknotes;
a deposit discriminating unit discriminating the loose banknotes accepted by said banknote input portion; and
banknote storage portions stored with the loose banknotes on the denomination-by-denomination basis on the basis of a result of the distinction made by said deposit discriminating unit,
said monitoring server including:
a verification instructing unit giving a verification instruction; and
a verification command transmitting unit transmitting a verification command to said banknote-and-coin handling system on the basis of the verification instruction given by said verification instructing unit,
wherein said banknote-and-coin handling system further includes:
a verification processing unit executing a verification process based on the verification command transmitted by said verification command transmitting unit; and
a verification result transmitting unit transmitting a result of the verification of said verification processing unit to said monitor server.

2. A verification system for a banknote-and-coin handling system according to claim 1, further comprising a central terminal connected to said monitor server,
wherein said monitor server further includes:
a judging unit making a judgment about a verification result transmitted from said verification result transmitting unit; and
a judgment result transmitting unit transmitting a judgment result of said judging unit to said central terminal.

3. A verification system for a banknote-and-coin handling system according to claim 1, wherein said verification command transmitting unit transmits the verification command off an operation time.

4. A verification system for a banknote-and-coin handling system according to claim 1, wherein said monitor server further includes a verification reservation setting unit that sets a verification reservation date and time, and
said verification command transmitting unit transmits the reservation date and time set by said verification reservation setting unit.

5. A verification system for a banknote-and-coin handling system according to claim 4, wherein said verification reservation setting unit unperiodically sets the reservation date and time.

6. A verification system for a banknote-and-coin handling system according to claim 4, wherein said verification reservation setting unit sets the reservation date and time at intervals of a predetermined period.

7. A verification system for a banknote-and-coin handling system according to claim 1, wherein said verification command transmitting unit makes a choice at intervals of one day and transmits the verification command when the choice is hit.

8. A verification system for a banknote-and-coin handling system according to claim 1, wherein said verification processing unit counts the loose coins stored in said coin storage portions and the loose banknotes stored in said banknote storage portions, and
said verification result transmitting unit transmits end information, a count result of said verification processing unit and balance data of the loose coins and the loose banknotes to said monitor server.

9. A verification system for a banknote-and-coin handling system according to claim 8, wherein said verification processing unit counts the loose coins and the loose banknotes excluding reject coins and reject banknotes.

10. A verification system for a banknote-and-coin handling system according to claim 8, wherein said verification processing unit counts the reject coins accepted by said hopper and the reject banknotes accepted by said banknote input portion.

11. A verification system for a banknote-and-coin handling system according to claim 1, wherein said verification result transmitting unit transmits a mail showing the verification result to said monitor server.

12. A verification system for a banknote-and-coin handling system according to claim 11, wherein said verification result transmitting unit transmits a mail showing the verification result to a mobile communication terminal.

13. A banknote-and-coin handling system comprising;
a banknote machine for depositing, dispensing, and sorting that handles banknotes; and
a coin machine for depositing, dispensing, and sorting that handles coins,
said coin machine for depositing, dispensing, and sorting including:
a hopper accepting inputted loose coins;
a discriminating portion discriminating between the loose coins accepted by said hopper;
coin storage portions stored with the loose coins on a denomination-by-denomination basis on the basis of a result of the distinction made by said discriminating portion; and
a coin packing unit taking a predetermined number of loose coins out of said coin storage portions and packing the predetermined number of taken-out coins into packed coins,
said banknote machine for depositing, dispensing, and sorting including:
a banknote input portion accepting the inputted loose banknotes;
a deposit discriminating unit discriminating the loose banknotes accepted by said banknote input portion;
banknote storage portions stored with the loose banknotes on the denomination-by-denomination basis on the basis of a result of the distinction made by said deposit discriminating unit; and
a bundle printing unit feeding out a predetermined number of loose banknotes from said banknote storage portions, bundling the predetermined number of fed-out loose banknotes with a bundling band into a banknote bundle, and a piece of printing processing information showing a content of the process conducted for the banknote bundle on the bundling band.

14. A banknote-and-coin handling system according to claim 13, wherein said bundle printing unit prints off-machine banknote information when the banknote bundle is organized by the loose banknotes accepted by said banknote input portion, and prints in-machine banknote information when the banknote bundle is organized by the banknotes stored in said banknote storage portions.

15. A banknote-and-coin handling system according to claim 13, wherein said bundle printing unit prints discharge banknote bundle information when the banknote bundle is discharged outside said machine, and prints storage banknote bundle information when the banknote bundle is stored inside said machine.

16. A banknote-and-coin handling system according to claim 13, wherein said bundle printing unit prints processing time information that represents time of a process executed for the banknote bundle.

17. A banknote-and-coin handling system according to claim 13, wherein said bundle printing unit prints operator information that specifies an operator involved in the process executed for the banknote bundle.
